(19) United States
(12) Patent Application Publication
(10) Pub. No.: US 2007/0212257 A1
(43) Pub. Date: Sep. 13, 2007

(54) IN-LINE QUADRATURE AND ANTI-REFLECTION ENHANCED PHASE QUADRATURE INTERFEROMETRIC DETECTION

(75) Inventors: David D. Nolte, Lafayette, IN (US); Manoj Varma, West Lafayette, IN (US); Ming Zhao, West Lafayette, IN (US)

Correspondence Address: BOSE MCKINNEY & EVANS LLP;JAMES COLES, 135 N PENNSYLVANIA ST, SUITE 2700, INDIANAPOLIS, IN, 46204, US

(73) Assignee: Purdue Research Foundation, West Lafayette, IN (US)

(21) Appl. No.: 11/675,359

(22) Filed: Feb. 15, 2007

Related U.S. Application Data
(60) Provisional application No. 60/774,273, filed on Feb. 16, 2006.
(60) Provisional application No. 60/868,071, filed on Nov. 30, 2006.

(51) Int. Cl. G01N 21/00

(52) U.S. Cl. 422/57

(57) ABSTRACT

Method and apparatus for use with a probe beam and detector for detecting the presence of a target analyte in a sample. The apparatus includes a substrate; and a biolayer located on the substrate designed to react to target analyte when the sample is deposited on the biolayer. The substrate can be selected to substantially minimize reflectance by the substrate while substantially maintaining scattering by the target analyte. The substrate can be designed so waves reflected by the substrate are substantially in quadrature with waves scattered by target analyte; or so waves reflected by the substrate and scattered by target analyte interfere in the far field and directly create intensity modulation detectable by the detector. The biolayer can include a plurality of spots, and the spots can be grouped into unit cells having specific antibodies and non-specific antibodies for reacting with target analyte.

### CROSS-REFERENCE TO RELATED APPLICATIONS

This application claims the benefit of U.S. Provisional Application Ser. No. 60/774,273, filed on Feb. 16, 2006, entitled “In-Line Quadrature Interferometric Detection,” and U.S. Provisional Application Ser. No. 60/868,071, filed on Nov. 30, 2006, entitled “In-Line Quadrature Interferometric Detection,” each of which is incorporated herein by reference.

### FIELD OF THE INVENTION

The present invention generally relates to apparatus, methods and systems for detecting the presence of one or more target analytes or specific biological material in a sample, and more particularly to a laser scanning system for detecting the presence of biological materials and/or analyte molecules bound to target receptors on a disc by sensing changes in the optical characteristics of a probe beam reflected from the disc by the materials and/or analytes.

### BACKGROUND

In many chemical, biological, medical, and diagnostic applications, it is desirable to detect the presence of specific molecular structures in a sample. Many molecular structures such as cells, viruses, bacteria, toxins, peptides, DNA fragments, and antibodies are recognized by particular receptors. Biochemical technologies including gene chips, immunological chips, and DNA arrays for detecting gene expression patterns in cancer cells, exploit the interaction between these molecular structures and the receptors. [For examples see the descriptions in the following articles: Sanders, G. H. W. and A. Manz, Chip-based Microsystems for genomic and proteomic analysis. Trends in Anal. Chem., 2000, Vol. 19(6), p. 364-378. Wang, J., From DNA biosensors to gene chips. Nucl. Acids Res., 2000, Vol. 28(16), p. 3011-3016; Hagman, M., Doing immunology on a chip. Science, 2000, Vol. 290, p. 82-83; Marx, J., DNA Arrays reveal cancer in its many forms. Science, 2000, Vol. 289, p. 1670-1672]. These technologies generally employ a stationary chip prepared to include the desired receptors (those which interact with the target analyte or molecular structure under test). Since the receptor areas can be quite small, chips may be produced which test for a plurality of analytes. Ideally, many thousand binding receptors are provided to provide a complete assay. When the receptors are exposed to a biological sample, only a few may bind a specific protein or pathogen. Ideally, these receptor sites are identified in as short a time as possible.

One such technology for screening for a plurality of molecular structures is the so-called immunological compact disk, which simply includes an antibody microarray. [For examples see the descriptions in the following articles: Ekins, R., F. Chu, and E. Biggart, Development of microspot multi-analyte ratiometric immunoassay using dual flourescent-labelled antibodies. Anal. Chim. Acta, 1989, Vol. 227, p. 73-96; Ekins, R. and F. W. Chu, Multianalyte microspot immunoassay—Microanalytical “compact Disk” of the future. Clin. Chem., 1991, Vol. 37(11), p. 1955-1967; Ekins, R., Ligand assays: from electrophoresis to miniaturized microarrays. Clin. Chem., 1998, Vol. 44(9), p. 2015-2030]. Conventional fluorescence detection is employed to sense the presence in the microarray of the molecular structures under test. Other approaches to immunological assays employ traditional Mach-Zender interferometers that include waveguides and grating couplers. [For examples see the descriptions in the following articles: Gao, H., et al., Immunosensing with photo-immobilized immunoreagents on planar optical wave guides. Biosensors and Bioelectronics, 1995, Vol. 10, p. 317-328; Maisenholder, B., et al., A GaAs/AlGaAs-based refractometer platform for integrated optical sensing applications. Sensors and Actuators B, 1997, Vol. 38-39, p. 324-329; Kunz, R. E., Miniature integrated optical modules for chemical and biochemical sensing. Sensors and Actuators B, 1997, Vol. 38-39, p. 13-28; Djibendorfer, J. and R. E. Kunz, Reference pads for miniature integrated optical sensors. Sensors and Actuators B, 1997 Vol. 38-39, p. 116-121; Brecht, A. and G. Gauglitz, recent developments in optical transducers for chemical or biochemical applications. Sensors and Actuators B, 1997, Vol. 38-39, p. 1-7]. Interferometric optical biosensors have the intrinsic advantage of interferometric sensitivity, but are often characterized by large surface areas per element, long interaction lengths, or complicated resonance structures. They also can be susceptible to phase drift from thermal and mechanical effects.

While the abovementioned techniques have proven useful for producing and reading assay information within the chemical, biological, medical and diagnostic application industries, developing improved fabrication and reading techniques with improvement in performance over existing technology is desirable.

### SUMMARY

One embodiment according to the present invention includes an apparatus for use with an optical probe beam and a detector for detecting the presence of a target analyte in a sample. The apparatus includes a substrate and a biolayer located on the substrate, the biolayer consisting of a distribution of molecular dipoles; or alternatively having an effective thickness and a refractive index; and the substrate having a reflection coefficient. In this embodiment, the magnitude of the substrate reflection coefficient is substantially minimized. In this embodiment, the substrate can include a dielectric material including silicon or a silicon dioxide layer on silicon. The biolayer and the substrate can be designed such that the scattered wave from the probe beam hitting the target analyte is substantially in-quadrature with the reflected wave from the probe beam hitting the substrate. Alternatively, the biolayer and the substrate can be designed to substantially maximize the electric field strength at the surface of the biolayer

Another embodiment according to the present invention includes an apparatus for use with a probe beam and a detector for detecting the presence of a target analyte in a sample, where the apparatus includes a biolayer; and a structure comprising a support layer on a substrate. In this embodiment, the magnitude of the substrate reflection coefficient is substantially minimized. In this embodiment, the thickness of the support layer can be selected such that the scattered wave from the top of the support layer is substantially out-of-phase with the reflected wave from the bottom of the support layer.

A further embodiment according to the present invention includes a method for detecting the presence of a target analyte in a sample. The method includes providing a substrate having a plurality of analyzer molecules distributed about the substrate; contacting a sample to at least some of the analyzer molecules; scanning the substrate with a probe beam; and detecting one of the presence or absence of a target analyte in the sample based on the reflected signal from the probe beam; wherein the detecting includes conversion of phase modulation into intensity modulation at the detector.

A further embodiment according to the present invention includes an apparatus for use with an optical probe beam and a detector for detecting the presence of a target analyte in a sample. The apparatus includes a substrate and a biolayer located on the substrate, the biolayer having a refractive index and the substrate having a reflection coefficient. In this embodiment, the biolayer and the substrate can be designed such that the scattered wave from the probe beam hitting the target analyte molecules is substantially in-phase with the reflected wave from the probe beam hitting the substrate surface.

A further embodiment according to the present invention includes an apparatus for use with a probe beam and a detector for detecting the presence of a target analyte in a sample, where the apparatus includes a biolayer; and a structure comprising a support layer on a substrate. In this embodiment, the thickness of the support layer can be selected such that the scattered wave from the top of the support layer is substantially in quadrature with the reflected wave from the bottom of the support layer. The method includes detecting one of the presence or absence of a target analyte in the sample based on the reflected signal from the probe beam; wherein the detecting includes direct conversion of phase modulation into intensity modulation. The detecting can be done without apertures or split detectors. The detecting can include detecting the scattered wave returned from the target analyte and the reflected wave returned from the substrate, the scattered wave being substantially in-phase with the reflected wave.

A further embodiment according to the present invention includes an apparatus for use with a probe beam and a detector for detecting the presence of a target analyte in a sample, where the apparatus includes a biolayer; and a structure comprising a support layer on a substrate. In this embodiment, the thickness of the support layer can be varied across the substrate such that the phase relationship between the waves reflected from the top and the bottom of the support layer can vary continuously between the condition of phase quadrature and the condition of being in-phase. The detecting can be done both with and without apertures or split detectors to convert the phase modulation caused by the target analyte into intensity modulation at the detector.

Additional embodiments, aspects, and advantages of the present invention will be apparent from the following description.

### BRIEF DESCRIPTION OF THE FIGURES

FIG. 1 is a schematic illustration of reflection and scattering caused by a molecule on a mirror and the combination of scattered and reflected waves in the far field;

FIG. 2 is an illustration of wavefunctions and boundary conditions of a uniform layer of molecules on a mirror;

FIG. 3 is a graph illustrating differential phase-contrast intensity modulation for a monolayer biofilm on an antireflection structure as a function of the support thickness for different substrate refractive indexes;

FIG. 4 is a graph illustrating reflectance versus support layer thickness for the conditions in FIG. 3;

FIG. 5 is a graph illustrating absolution intensity modulation versus support layer thickness, the product of FIG. 3 with FIG. 4;

FIG. 6A is a graph illustrating squared electrical field versus position for gold on glass;

FIG. 6B is a graph illustrating relative intensity modulation for gold on glass versus gold thickness in response to a monolayer;

FIG. 7 is a graph illustrating phase modulation and reflectance modulation versus top layer thickness caused by a bio monolayer on a dielectric stack;

FIG. 8 is a graph illustrating phase and reflectance versus thickness for an anti-reflection layer on ZrO₂ with and without a biolayer;

FIG. 9 is a graph illustrating relative intensity modulation versus support thickness for antireflection layer on ZrO₂;

FIG. 10 is a graph illustrating electrical field strength at the surface of silicon versus position for real, imaginary, and total magnitude electric filed components;

FIG. 11 is a graph illustrating squared electrical field strength versus position for a silicon surface and an anti-node surface;

FIG. 12 is a graph illustrating electrical field strength versus position at the surface of quarter-wave oxide-on-silicon with and without an antibody monolayer;

FIG. 13 is a graph illustrating phase shift caused by the biolayer and reflectance as a function of oxide thickness on silicon;

FIG. 14 is a graph illustrating differential phase contrast and direct intensity modulation in response to an 8 nm monolayer of antibody versus oxide thickness showing the response of the phase and intensity channels and their summation in quadrature;

FIG. 15 is a graph illustrating electric field versus position for an anti-reflection-coated silicon surface with and without an antibody layer;

FIG. 16 is a graph illustrating differential phase contrast and direct intensity modulation caused by an antibody biolayer;

FIG. 17 is a schematic drawing of the disc structure of an embodiment of the in-line biological disc and the reflection of light rays therefrom;

FIG. 18 is a graph illustrating the intensity shift caused by 1 nm of protein versus oxide thickness for several different wavelengths;

FIG. 19A is a graph illustrating the intensity shift produced by protein measured directly as a time trace of total light intensity;

FIG. 19B shows a two dimensional surface profile obtained by putting time traces taken at consecutive radii together into a 2D display;

FIG. 20A is a graph illustrating a distribution of assay signal for each unit cell as a function of dose for an embodiment of the in-line system;

FIG. 20B is a graph illustrating a the dose response curve for an embodiment of the in-line system;

FIG. 21 is a graph illustrating the measurement error versus the number of assays per disc;

FIG. 22 is a graph illustrating the concentration detection limit set by the measurement error and the response curve;

FIG. 23 shows a cross section across a single spot showing an outer ridge and internal ridges;

FIG. 24 shows a high-resolution scan of a spot with a clear ring structure;

FIG. 25 is a schematic illustration and a graph of improved discrimination between molecular phase and Rayleigh scattering at 120 nm oxide thickness;

FIG. 26 shows a spatial scan of approximately 200 spots on a 120 nm oxide biological disc across 2.5 mm with spot diameters of approximately 120 microns and heights of about 3 nm;

FIG. 27 shows an example of a “unit cell” with target and reference spots placed in a 2×2 array, and the data on the right shows unit cell spots of approximately 120 micron diameter printed onto a 120 nm oxide biological disc;

FIG. 28 shows an image subtraction protocol with a postscan image being subtracted from a prescan image to produce a resultant difference image on the right showing the change in surface height;

FIG. 29 shows an the detection sensitivity of in-line quadrature on a 120 nm oxide biological disc, the scan data on the upper left providing two line plots on the right, one through the center of an IgG spot, and the other on the so-called land;

FIG. 30 shows a histogram of the root height variance between two scans of the same disc before and after a 20 hour buffer wash;

FIG. 31 shows an embodiment of a disc layout with 25,600 spots placed in a 2×2 unit cell pattern with 100 radial spots and 256 angular spokes; and

FIG. 32 is assay data showing change in spot mass as a function of analyte concentration for a series of incubations on a 120 nm oxide disc, the curve being a fit to a Langmuir function.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

This application is related to pending U.S. patent application Ser. No. 10/726,772, entitled “Adaptive Interferometric Multi-Analyte High-Speed Biosensor,” filed Dec. 3, 2003 (published on Aug. 26, 2004 as U.S. Patent Publication No. 2004/0166593), which is a continuation-in-part of U.S. Pat. No. 6,685,885, entitled “Bio-Optical Compact Disk System,” filed Dec. 17, 2001 and issued Feb. 3, 2004, the disclosures of which are all incorporated herein by this reference. This application is also related to U.S. patent application Ser. No. 11/345,462 entitled “Method and Apparatus for Phase Contrast Quadrature Interferometric Detection of an Immunoassay,” filed Feb. 1, 2006; and also U.S. patent application Ser. No. 11/345,477 entitled “Multiplexed Biological Analyzer Planar Array Apparatus and Methods,” filed Feb. 1, 2006; and also U.S. patent application Ser. No. 11/345,564, entitled “Laser Scanning Interferometric Surface Metrology,” filed Feb. 1, 2006; and also U.S. patent application Ser. No. 11/345,566, entitled “Differentially Encoded Biological Analyzer Planar Array Apparatus and Methods,” filed Feb. 1, 2006, the disclosures of which are all incorporated herein by this reference.

Prior to describing various embodiments of the invention the intended meaning of quadrature in the interferometric detection system(s) of the present invention is further explained. In some specific applications quadrature might be narrowly construed as what occurs in an interferometric system when a common optical “mode” is split into at least 2 “scattered” modes that differ in phase by about N*π/2 (N being an odd integer). However, as used in the present invention (and the previously referred to issued patents and/or pending applications of Nolte et al.) an interferometric system is in quadrature when at least one mode “interacts” with a target molecule and at least one of the other modes does not, where these modes differ in phase by about N*π/2 (N being an odd integer). This definition of quadrature is also applicable to interferometric systems in which the “other mode(s),” referring to other reference waves or beams, interact with a different molecule. The interferometric system may be considered to be substantially in the quadrature condition if the phase difference is π/2 (or N*π/2, wherein N is an odd integer) plus or minus approximately twenty or thirty percent.

Summing in quadrature is a separate use of the term “quadrature” not directly related to phase quadrature of interferometry. Two independent signals are summed in quadrature by taking the sum of their squared magnitudes. Summing in quadrature is a method for taking two varying output signals that arise from varying properties of a system being measured, and combining them into a single measurement that is substantially constant.

The phrase “in-phase” in the present invention is intended to describe in-phase constructive interference, and “out of phase” is intended to describe 180-degree-out-of-phase destructive interference. This is to distinguish these conditions, for both of which the field amplitudes add directly, from the condition of being “in phase quadrature” that describes a relative phase of an odd number of π/2.

Optical interferometric detection of biomolecules at surfaces depends on the phase shift imposed by the molecules on a probe optical field. For a monolayer of macromolecules such as antibodies on a typical surface such as glass this phase shift is typically only a few percent of a radian. This small phase shift produces a detected intensity modulation of only a few percent when operating in interferometric quadrature. Treatment of surfaces with dielectric layers can enhance the molecular phase shift and the relative intensity modulation in quadrature interferometry. Immobilization of molecules on anti-nodal high-reflectivity mirrors produces enhancements of about three times. Immobilization of molecules on anti-reflection surfaces, on the other hand, can produce an enhancement of about fifteen times. This is because the low-reflectivity of the surface reduces the far-field contribution from the direct field relative to the molecular scattered field, thereby enhancing the molecular phase shift. This shifted field is detected relative to a reference field in a condition of self-referencing quadrature in Phase-Contrast (PC) class. In addition, using inline quadrature can directly convert the phase modulation into intensity modulation without the need for apertures or split detectors. The PC-class of quadrature interferometric detection is discussed in U.S. patent application Ser. No. 11/345,462, filed Feb. 1, 2006 and entitled “Method and Apparatus for Phase Contrast Quadrature Interferometric Detection of an Immunoassay,” which was previously incorporated herein by reference.

The origin of refractive index rests in molecular scattering. A field incident on a molecule is scattered into the far field with a scattering coefficient f:
E_{scat}=fE₀e^{ikr}
The scattering coefficient f is real and in phase with the exciting field E₀. The total far field, including contributions from both the direct wave and the scattered wave, is given by:
E_{far}=iE₀+fE₀e^{ikr}
where the factor of i in the first term arises from the diffraction of the direct field from the near field into the far field. Because the two terms have a 90 degree phase shift, the molecular scattering produces a phase shift given by:
φ=tan⁻¹(f)
This is the phase shift associated with scattering from a single molecule. When an ensemble of molecules in a finite region produce the scattering, the phase can be attributed to a refractive index of the molecular medium. As the medium becomes more dense, local-field corrections modify the molecular scattering through depolarization fields, but the basic origin of refractive index is in the molecular scattering.

Interferometric optical biosensors can be used to detect the phase shift on a probe field caused by the presence of biomolecules. A monolayer of molecules produces a phase shift (double pass in air) of:
δ=2(n−1)k₀d
where k₀=2π/λ. For λ=635 nm and the refractive index of the biolayer n≈1.3, the double-pass phase shift is approximately Δφ=0.0475 rad. When detected relative to a reference wave in quadrature, this produces a relative intensity modulation of only a few percent.

The phase shift caused by molecular scattering at surfaces can be enhanced by reducing the contribution of the direct field, while keeping the molecularly scattered field constant. This can be accomplished by placing dielectric layers on the substrate that control both the phase and the amplitude of the reflected energy that constitutes the direct wave.

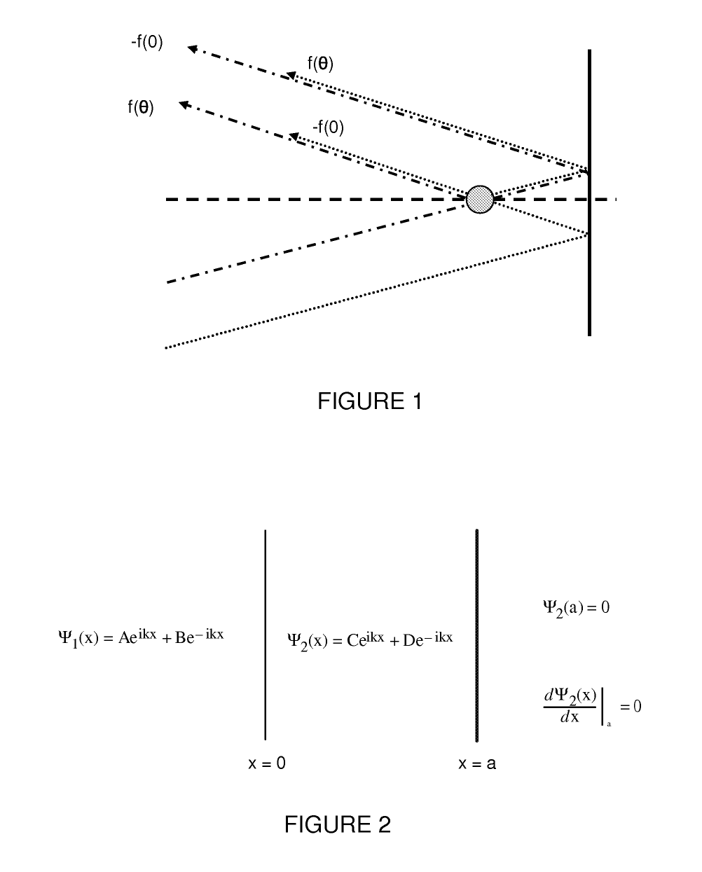

A molecule in close proximity to a perfect (metallic) mirror experiences a node in the electromagnetic field because of the boundary condition at the surface of the mirror. The scattering amplitudes are shown in FIG. 1. The molecule on the mirror scatters the incident wave, and combinations of scattered and reflected waves combine in the far field. The net scattering amplitude is:
f_{Net}=2f(θ)−2f(0)
where θ=180° for normal incidence. For isotropic scattering, f(θ)=f(0), the scattered contribution to the far field cancels and the net scattering amplitude is zero, so the molecule is “invisible” on a nodal surface even in terms of the phase shift it imparts to the probe beam. Conversely, for a mirror with an anti-node at the surface, the net scattering amplitude becomes:
f_{Net}=2f(θ)+2f(0)
resulting in an amplitude two times larger than for an isolated molecule (double pass) and hence a two-times larger phase shift. These simple results reflect the fact that the scattering by the molecule is proportional to the field, which is zero at a node and two-times the incident field in an antinode.

For the more general case of a dielectric surface with reflection coefficient r, the net scattering amplitude is:
f_{Net}=f(0)(1+r²)+f(θ)2r
which for isotropic scattering becomes:
f_{Net}=f_{scat}(1+r)²
The effect on the far-field is:
E_{far}=rE₀+iE₀f_{scat}(1+r)²
with a phase contribution:

$${ϕ}_{reflect} = {tan}^{- 1} ( f \frac{{( 1 + r )}^{2}}{r} )$$

in the case when r is real, and more generally as:

$${ϕ}_{reflect} = {tan}^{- 1} ( \frac{{r}_{2} + f ( 1 + {r}_{1}^{2} - {r}_{2}^{2} + 2 {r}_{1} )}{{r}_{1} - 2 {fr}_{2} - 2 {fr}_{1} {r}_{2}} )$$

when r=r₁+ir₂ is complex.

The important aspect of the above equation is the inverse dependence on the reflection coefficient r. As r goes to zero, for an anti-reflection condition, the phase shift asymptotes to π/2. This limiting phase shift is because of the π/2 phase difference between the direct and scattered wave. When r is zero, there is no direct wave. The origin of the phase enhancement is therefore clear; the contribution from the direct wave can be made arbitrarily small relative to the scattered contribution.

To complete this heuristic approach of a molecule near a surface, the surface height of the molecule can be included in the derivation. This leads to a far field given by:
E_{far}=rE₀+iE₀f(θ)[1+r²e^{i2δ}]+iE₀f(0)2re^{iδ}
with a phase shift of:

$${ϕ}_{far} = {tan}^{- 1} [ \frac{f ( θ ) [ 1 + {r}^{2} cos 2 δ ] + f ( 0 ) 2 r cos δ}{r \{ 1 + f ( θ ) r sin 2 δ + f ( 0 ) 2 sin δ \}} ]$$

which still contains the 1/r dependence derived before (where r is again real).

While the emphasis above has been on mechanisms to enhance molecular phase shifts, the goal is the detection of enhanced intensity modulation in the far field arising from molecular scattering. The physical process that converts phase modulation into intensity modulation at the detector is the combination of the probe wave (carrying the phase modulation from the biolayer) with a reference wave that is in phase quadrature (or 90° relative phase). In the condition of quadrature, the intensity modulation at the detector is a maximum and depends linearly on the amount of phase modulation.

One method to attain the quadrature condition is to detect phase modulation through the observation of two waves, one passing through the analyte and one falling on the substrate adjacent to the analyte, at an angle called the quadrature angle. The two waves at the quadrature angle are in quadrature, and the intensity change is directly proportional to the protein height. This is called phase-contrast quadrature and acquires a differential phase contrast signal. The anti-reflection enhancement of molecular phase shift described in the preceding paragraphs represents a new embodiment of differential phase contrast quadrature. The differential phase signal is enhanced by reducing the reflectance of the supporting substrate.

A second method to attain the quadrature condition is to detect the phase modulation directly by designing the substrate to have a reflection coefficient that is shifted in phase by 90 degrees. This condition is in-between the nodal and anti-nodal conditions. When the reflected field has a 90 degree phase shift in the near field, the reflected reference and the scattered molecular signal become in phase in the far field, interfering and directly creating intensity modulation. Thus, no differential phase contrast scheme is needed to detect it. Surface analytes can be measured directly.

This form of direct quadrature detection is closely related to the case of anti-reflection coatings. When the support layer is a little off the quarter-wave condition corresponding to a reflectance minimum, the reflected wave can have the required 90 degree phase shift, creating the condition for direct detection in the far field without the need for quadrant detectors. Therefore, by operating near a reflectance minimum condition, the differential phase contrast and this direct detection of phase both benefit from the anti-reflection enhancement.

To make the nomenclature clear, we shall use two different expressions for the embodiments introduced in this application. Anti-reflection enhancement of differential phase contrast (AR-enhanced DPC) describes the enhanced detection of differential phase contrast signals caused by placing the molecules or biolayers on a substrate substantially in or near an anti-reflectance condition. In-line quadrature describes the direct phase-to-intensity conversion that occurs when the wave scattered from the target analyte molecules are substantially in-phase with the wave reflected from the substrate. When theoretical descriptions or results are common to both the embodiments, we shall refer to them collectively as simply being in quadrature.

To further discuss the advantages of the different embodiments, the signal-to-noise ratio, in addition to the phase shift, also impacts interferometric detection. This depends on the specific noise contributions such as relative intensity noise (RIN), shot noise and system noise.

In the condition of quadrature detection, for which the phase-shifted field is mixed with a reference field 90° shifted phase, the intensity is:
I_{Q}=Iₒ[r²+2rf(1+r)²]
The relative change in intensity is then:

$$\frac{Δ I}{I} = \frac{2 {f ( 1 + r )}^{2}}{r}$$

as expected for small scattering.

If RIN dominates the detection noise, then the noise is:
I_{RIN}=(RIN)r²
and the signal-to-noise ratio is then:

$$S / N {\vert}_{RIN} = \frac{2 {rf ( 1 + r )}^{2}}{( RIN ) {r}^{2}} = \frac{1}{( RIN )} \frac{2 {f ( 1 + r )}^{2}}{r}$$

Note in this case that the signal-to-noise increases as r goes to zero. Therefore, the decreasing photon flux does not impact the increased sensitivity, and the best condition in this case is an anti-reflection surface. Low reflectance can be offset by higher laser power.

If constant system noise dominates the detection noise, the signal-to-noise ratio is:

$$S / N {\vert}_{sys} = {I}_{0} \frac{2 {rf ( 1 + r )}^{2}}{{N}_{sys}}$$

which goes to zero as r goes to zero. This is therefore not advantageous, and the best condition in this case is high reflectance with an anti-node surface and using differential phase contrast detection.

In the fundamental limit of shot noise, the signal-to-noise ratio is:

$$S / N {\vert}_{Shot} = \frac{2 {rf ( 1 + r )}^{2}}{( SN ) \sqrt{2} r} = \frac{\sqrt{2} {f ( 1 + r )}^{2}}{( SN )}$$

where (SN) is a coefficient related to the shot noise magnitude. This S/N is independent of r in the small-r limit and is comparable to the free-space case of molecular phase shift.

Therefore, from the point of view of signal-to-noise performance, if the system noise can be reduced so that relative intensity noise dominates, then the anti-reflection condition gives the best enhancements in S/N. Low photon flux can be compensated by higher power laser sources and by lower-intensity detectors such as APDs. Anti-reflection coatings can also be more economical than multi-layer mirror stacks.

When the molecular layer becomes dense, it may more appropriately be modeled by a thin homogeneous layer with a refractive index n. FIG. 2 will be used to discuss a biolayer on a substrate with reflection coefficient r₀ in the absence of the layer that can be a complex value. The uniform layer has a thickness “d” and refractive index nₚ. The fields in the incident half-space and the protein layer are:
Eᵢ=Ae^{-ikx}+Be^{ikx}
Eₚ=Ce^{-ik}^{ₚ}^{x}+rCe^{ik}^{ₚ}^{x}
where kₚ=nₚk. By continuity of field and first-derivative these give:

$$A {ⅇ}^{- ⅈ kd} + B {ⅇ}^{ⅈ kd} = C {ⅇ}^{- ⅈ {k}_{p} d} + rC {ⅇ}^{ⅈ {k}_{p} d} \\ - ⅈ kA {ⅇ}^{- ⅈ kd} + ⅈ {kBe}^{ⅈ kd} = - ⅈ {k}_{p} C {ⅇ}^{- ⅈ {k}_{p} d} + ⅈ {k}_{p} rC {ⅇ}^{ⅈ {k}_{p} d}$$

Solving for C in each case gives:

$$C = \frac{{ⅇ}^{- ⅈ kd} + B {ⅇ}^{ⅈ kd}}{{ⅇ}^{- ⅈ {k}_{p} d} + r {ⅇ}^{ⅈ {k}_{p} d}}$$

$$C = \frac{- k {ⅇ}^{- ⅈ kd} + kB {ⅇ}^{ⅈ kd}}{- {k}_{p} {ⅇ}^{- ⅈ {k}_{p} d} + {k}_{p} r {ⅇ}^{ⅈ {k}_{p} d}}$$

Equating the two equations and solving for r′=B gives:

$${r}^{′} = {ⅇ}^{- 2 ⅈ kd} \frac{bk + {ak}_{p}}{bk - {ak}_{p}}$$

where:
a=(re^{ik}^{ₚ}^{d}−e^{-ik}^{ₚ}^{d})
b=(re^{ik}^{ₚ}^{d}+e^{-ik}^{ₚ}^{d})

This formula can be used to calculate the relationship between the reflection coefficient r between the protein layer and the substrate and the “bare” reflection coefficient r₀ of the substrate as:

$$\begin{matrix}r = \frac{( {r}_{0} + 1 ) k + ( {r}_{0} - 1 ) {k}_{p}}{( {r}_{0} + 1 ) k - ( {r}_{0} - 1 ) {k}_{p}} \\ = \frac{{r}_{0} - {r}_{p}}{1 - {r}_{0} {r}_{p}}\end{matrix}$$

Putting this into the solution for r′ gives

$${r}^{′} = {ⅇ}^{- 2 ⅈ kd} \frac{{r}_{p} + r {ⅇ}^{2 ⅈ {k}_{p} d}}{1 + {r}_{p} r {ⅇ}^{2 ⅈ {k}_{p} d}}$$

The expansion for small layer thickness d is:

$${r}^{′} = \frac{{ⅇ}^{- 2 ⅈ kd}}{( 1 + {rr}_{p} )} [ r + {r}_{p} + 2 ⅈ {rk}_{p} ⅆ \frac{( 1 - {r}_{p}^{2} )}{( 1 + {rr}_{p} )} ]$$

Using the relations:

$$1 + {rr}_{p} = \frac{1 - {r}_{p}^{2}}{1 - {r}_{0} {r}_{p}} and r + {r}_{p} = {r}_{0} \frac{1 - {r}_{p}^{2}}{1 - {r}_{0} {r}_{p}}$$

the expression for r′ becomes:

$${r}^{′} = {r}_{0} + 2 i ⅆ [ {k}_{p} \frac{( {r}_{0} - {r}_{p} ) ( 1 - {r}_{0} {r}_{p} )}{( 1 - {r}_{p}^{2} )} - {kr}_{0} ]$$

This last equation is interpreted in terms of the reference wave r₀. The additive term is the phase modulation of the layer that is also the molecularly scattered wave. This shows that, when the second term is in phase with r₀, the condition of in-line quadrature holds. And, when the second term is in quadrature with r₀, the condition of differential phase contrast holds.

While the condition of differential phase contrast vs. in-line quadrature is determined by the reflection coefficient of the substrate, the conversion from phase modulation to intensity modulation at the detector requires two independent detection modes. These two modes use an odd detector function for differential phase contrast, and an even detector function for in-line quadrature detection. The odd detector function is obtained by using a split detector and differencing the left and right halves. The even detector function is obtained simply by detecting the full beam.

In terms of the detector current in each case, this is given by:

$${i}_{DPC} = \frac{1}{2} {ϕ}_{Re} \frac{{\vert g ( x ) \vert}^{2}}{{\vert g ( 0 ) \vert}^{2}} ⊗ [ \frac{ⅆ h ( x )}{ⅆ x} + \frac{1}{6} \frac{{ⅆ}^{3} h ( x )}{ⅆ {x}^{3}} + … ]$$

where:

$${ϕ}_{Re} = \frac{4 π {n}_{p} cos {θ}_{0}}{λ} Re [ \frac{( {r}_{p} - {r}_{0} ) ( 1 - {r}_{0} {r}_{p} )}{{r}_{0} ( 1 - {r}_{p}^{2} )} ]$$

$$and$$

$${i}_{IL} = \frac{1}{2} {ϕ}_{Im} \frac{{\vert g ( x ) \vert}^{2}}{{\vert g ( 0 ) \vert}^{2}} ⊗ [ h ( x ) + \frac{1}{2} \frac{{ⅆ}^{2} h ( x )}{ⅆ {x}^{2}} + … ]$$

where:

$${ϕ}_{Im} = \frac{4 π {n}_{p} cos {θ}_{0}}{λ} Im ( \frac{( {r}_{p} - {r}_{0} ) ( 1 - {r}_{0} {r}_{p} )}{{r}_{0} ( 1 - {r}_{p}^{2} )} )$$

Note that the protein profile is either the odd derivatives, for differential phase contrast, or the even derivatives, for in-line quadrature. Both cases benefit from small reflectance because of the r₀ term in the denominator, and hence both are enhanced by working at or near a reflectance minimum.

In the above description, the phase of the wave scattered from the target analyte molecules is related to the phase of the wave scattered from the substrate. When these two waves are in-phase, then in-line quadrature results. When these two waves are in quadrature, then differential phase contrast results. The difference between these two conditions is set by the phase of r₀. To understand how to tune the magnitude and phase of r₀, it is instructive to consider the substrate to be composed of a support layer on a base material. The molecules or biolayers are on top of the support layer. The refractive index of the support layer can be chosen to substantially minimize the reflectance (the magnitude of the reflection coefficient). And the thickness of the support layer can be varied to tune the phase of the reflection to bring the detection into in-line quadrature or into differential phase contrast.

The simplest anti-reflection surface is the single quarter wave layer on a substrate with a reflection coefficient of:

$$r = \frac{{n}_{1} ( {n}_{0} - {n}_{s} ) cos kh + ⅈ ( {n}_{0} {n}_{s} - {n}_{1}^{2} ) sin kh}{{n}_{1} ( {n}_{0} + {n}_{s} ) cos kh + ⅈ ( {n}_{0} {n}_{s} + {n}_{1}^{2} ) sin kh}$$

for nₛ the refractive index of the base, n₁ the index of the support layer, and n₀ the index of the top space. The reflection coefficient goes to zero at the anti-reflection condition for a quarter-wave layer under the condition:
n₁²=n₀nₛ

The phase of the simple anti-reflection surface is real (in phase quadrature with the waves scattered from the target analyte molecules) when the support layer has a quarter-wave thickness. This gives the anti-reflection enhancement of differential phase contrast. When the support layer has a thickness of approximately an eighth of a wavelength, then the phase of the reflection coefficient becomes a purely imaginary number and the reflected wave is in-phase with the wave scattered by the molecules. In this case one sees that the wave reflected from the top of the support layer and the wave reflected from the bottom of the support layer are in phase quadrature. This is the condition of in-line quadrature.

Note that in-line quadrature has two modes of description that are mutually self-consistent. When viewed as a molecule on a substrate with a reflection coefficient, the in-line quadrature condition is attained when the wave scattered from the molecule and the wave reflected from the substrate are in phase. When viewed as a molecule on a support layer, the in-line quadrature condition is attained with the wave reflected from the top of the support layer and the wave reflected from the bottom of the support layer are in phase quadrature. These two views are consistent, because molecular scattering imposes a 90 degree phase shift on the scattered wave. The molecularly scattered wave is in phase quadrature with the top reflection, which is itself in phase quadrature with the bottom reflection. Two quadrature conditions add up to an in-phase condition, which is what converts the molecularly scattered wave directly into intensity modulation. In-line quadrature is called “in-line” because the reflections of the probe beam from the top and the bottom surfaces of the support layer are in line with each other. This type of in-line configuration puts in-line quadrature into the class of common-path interferometers. Common-path interferometry is essential for the stable detection of the small phases associated with the molecular phase shifts.

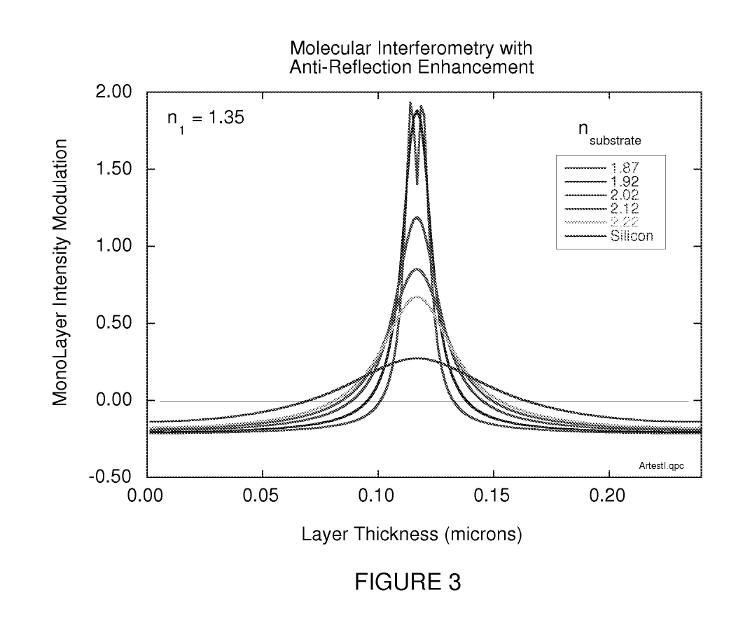

FIG. 3 shows the anti-reflection-enhanced differential phase-contrast intensity modulation for a monolayer biofilm on an antireflection structure as a function of the support thickness. In this case, the support is index-matched to the biolayer, and the substrate refractive indexes are shown. The simplest case to consider is a support layer that is index-matched to the biolayer with a refractive index of n₁=1.35, and a substrate with a refractive index nₛ=1.35²=1.82. The ideal anti-reflection case of nₛ=1.82 is not shown because the phase modulation begins to wrap.

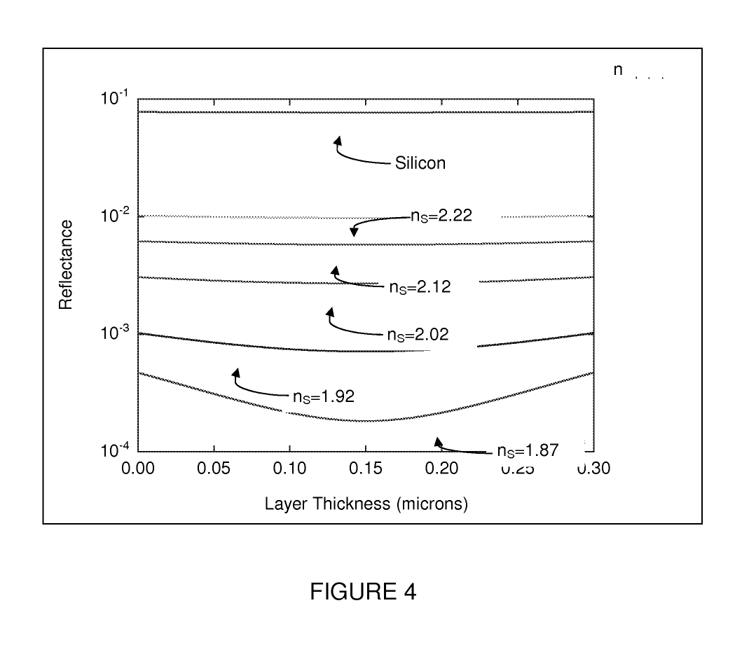

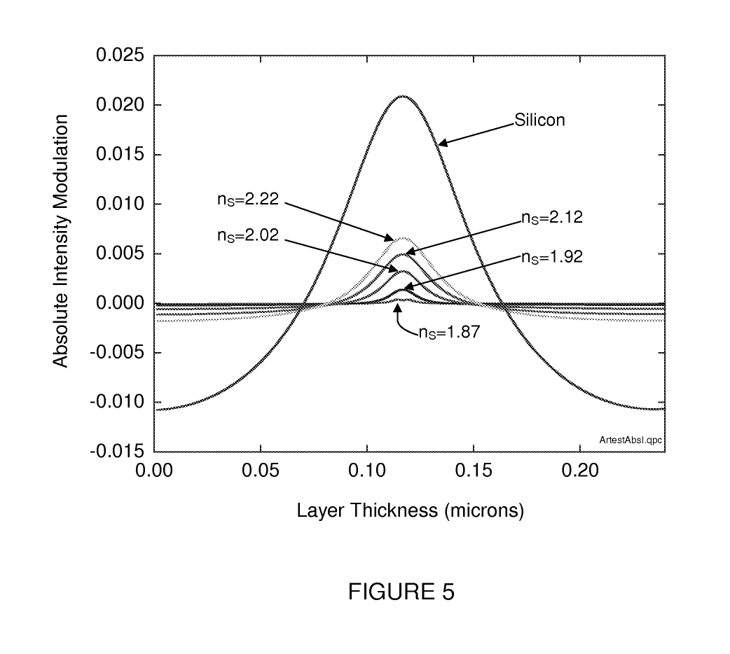

FIG. 4 shows the corresponding reflectances for the conditions shown in FIG. 3. As the substrate index approaches 1.82, the reflectance goes to zero. The low reflectance at the anti-reflection condition reduces the absolution intensity modulation, which is shown in FIG. 5. The absolute intensity modulation is the product of intensity modulation in FIG. 3 and the reflectance in FIG. 4. The absolute signal decreases as the anti-reflection condition is approached. As long as the relative intensity noise of the laser continues to dominate, the S/N is not adversely affected by the decreased absolution photon flux. Silicon as the substrate provides a balance between enhancing and decreasing absolute signals.

The most general situation involving multiple layers in the substrate and in the biolayer is modeled using the transfer matrix approach. Realistic complex refractive index of actual materials are easily incorporated in this approach. Common materials and substrate structures include gold, quarter-wave dielectric stacks, anti-reflection surfaces, and silicon with thin or thick oxides or other coatings.

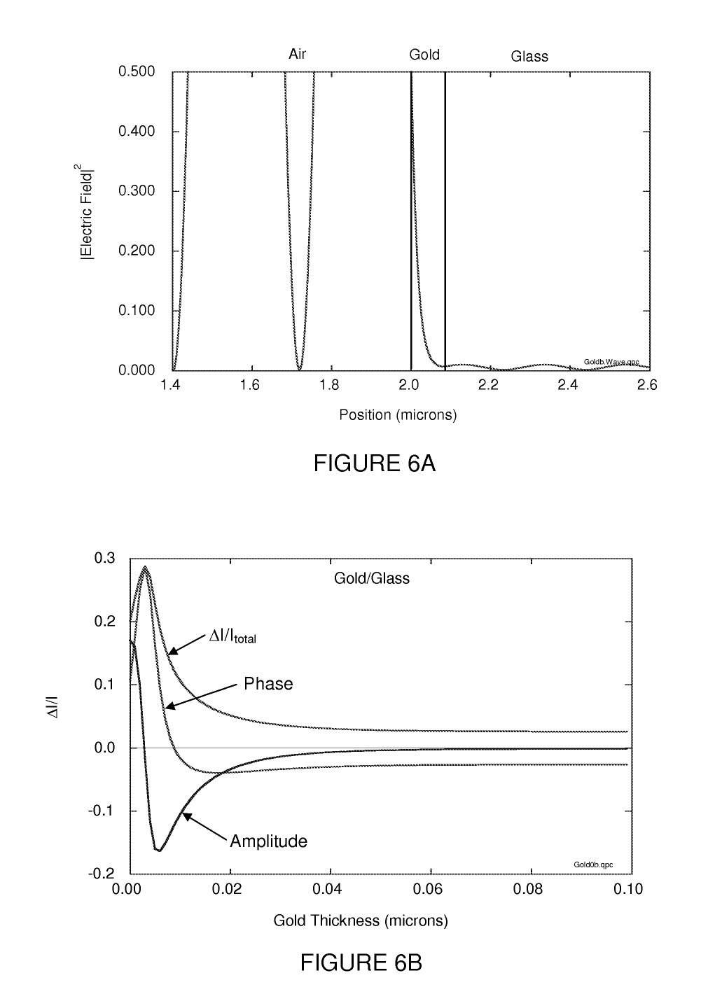

Thick gold behaves very close to a nodal high-reflectance surface. The presence of the field null near the surface makes biolayers nearly “invisible” on this surface. The squared field is shown in FIG. 6A for gold on glass with a gold thickness of 80 nm. The intensity at the surface of the gold is 0.5 compared with 4 for a perfect anti-nodal mirror, and decays rapidly inside the gold with a decay length of 16 nm. The relative intensity modulations for both differential phase contrast and in-line quadrature for gold on glass as a function of gold thickness are shown in FIG. 6B. The differential phase contribution to the intensity modulation is shown in FIG. 6B to be only 3% for a thickness of 16 nm. FIG. 6B also shows that at a thickness of about 3 nm of gold on glass, there is nearly a 30% differential phase contrast signal from a bio monolayer. The in-line intensity modulation is almost 20% for thicknesses slightly large and smaller than 3 nm. This suggests that thin gold on glass is a candidate for enhanced detection of both differential phase contrast and in-line conditions. However, gold of this thickness tends to aggregate rather than being a uniform layer. Gold on silicon, instead of glass, on the other hand does not lead to high phase shifts because of the large refractive index of silicon.

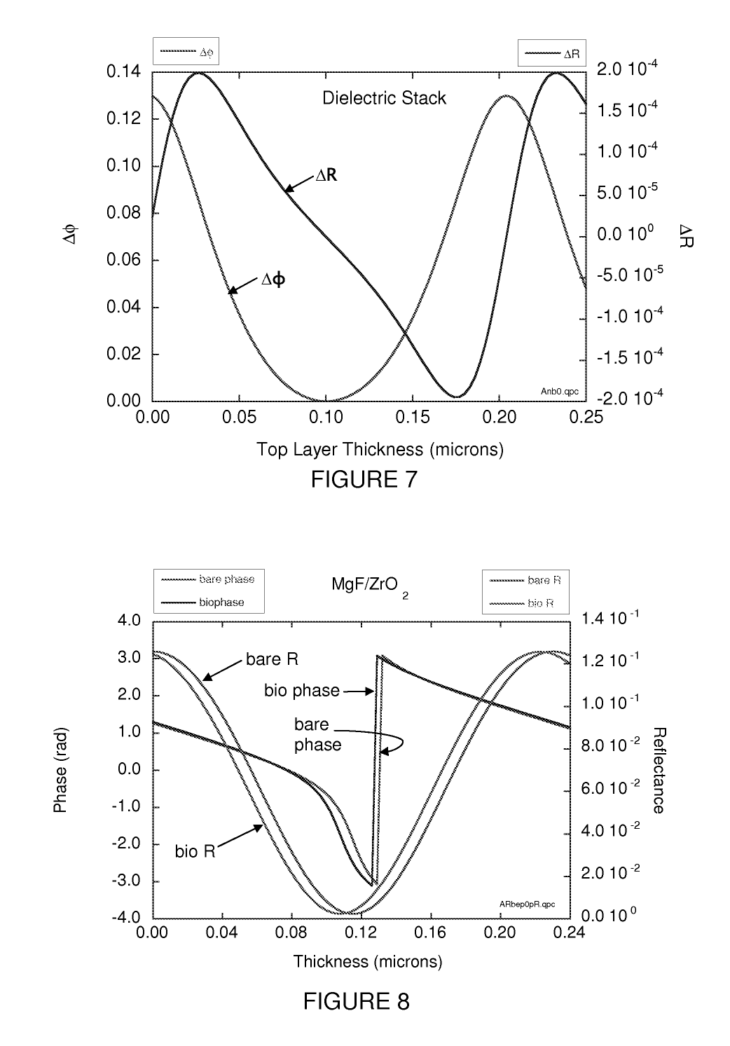

Dielectric quarter wave stacks are readily designed to have high reflectance, as well as control over the reflected phase. The two most common phase conditions are nodal-surfaces and anti-nodal-surfaces. In between these two conditions comes the case when the reflection coefficient takes on purely imaginary values and hence are in the in-line quadrature condition. FIG. 7 shows phase modulation and reflectance modulation caused by a bio monolayer on a dielectric stack. The surface begins as an anti-nodal condition, and goes to a nodal condition. In between is the “in-line” condition for which the reflectance modulation is negligible. This is because the high reflectance cannot be modified by the phase shift induced by the biolayer. Therefore, in-line quadrature does not apply to the case of high-reflectance substrates. But for differential phase contrast, the anti-nodal surface gives a phase shift roughly twice the double-pass phase from the layer. The enhanced differential phase contrast peak is also relatively broad with a FWHM of almost 100 nm, making the surface insensitive to slight drifts in layer thickness.

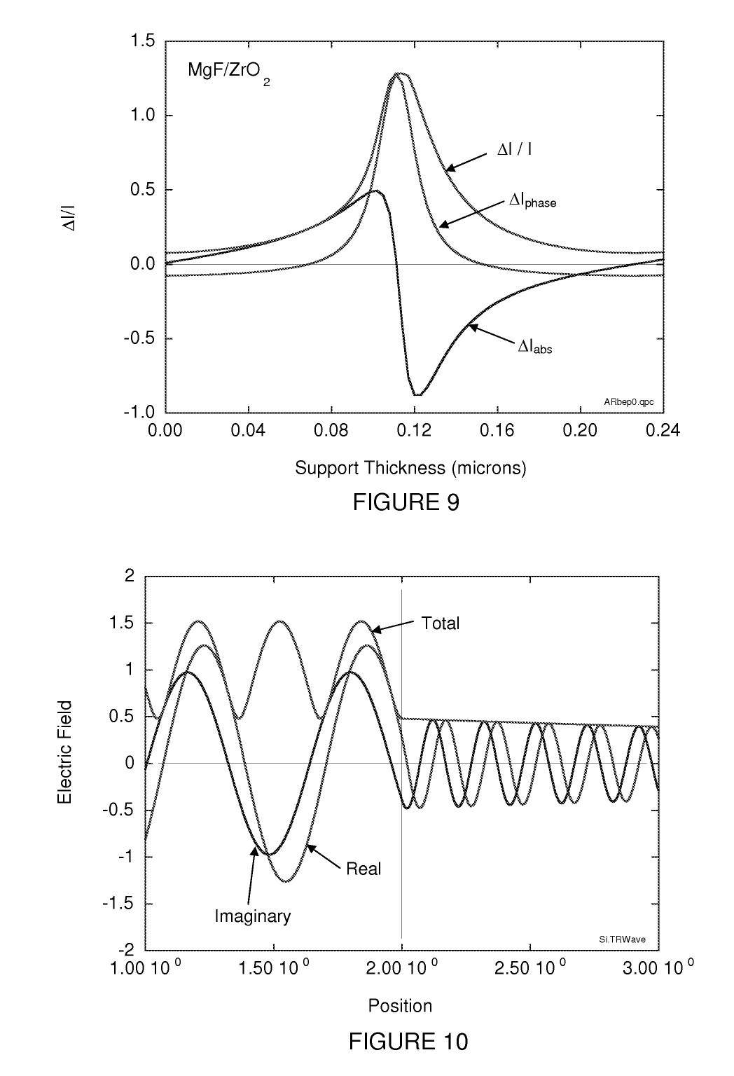

An anti-reflection surface can be obtained using quarter-wave layers on a substrate which can provide nearly perfect impedance matching to the substrate, driving reflectance to nearly zero. This anti-reflection surface enhances the phase shift caused by a biolayer on a surface. A potentially realistic structure is a quarter wave support layer of MgF (n=1.38) on a ZrO₂ substrate (n=2.2). The phase and reflectance for this structure with and without a biolayer is shown in FIG. 8. The phase jump near the reflectance minimum is pronounced in this case, and the effect of the biolayer is large. The relative intensity modulation for this structure is shown in FIG. 9. There are two contributions: one from the differential phase contrast, and one directly from the in-line amplitude modulation from the surface. The anti-reflection enhancement of the differential phase contrast is very large at the anti-reflection condition. The in-line effect is also large for this structure because the scattered wave and the reflected wave can be in phase when slightly off the anti-reflection condition, adding constructively in the far field. This in-line condition is direct quadrature which is not differential and hence gives absolute protein heights. The FWHM width of the enhancement is about 25 nm.

With a quadrant detector in the far field, it is possible to add the differential phase contrast and the in-line amplitude channels in quadrature because they are approximately orthogonal. The total intensity modulation is then:

$$\frac{Δ I}{I} = sqrt [ {( 2 sin Δ ϕ )}^{2} + {sin}^{2} \frac{Δ R}{R} ]$$

which is shown as the total curve in FIG. 9. The FWHM is broader for the total modulation, providing more stability for the detection method.

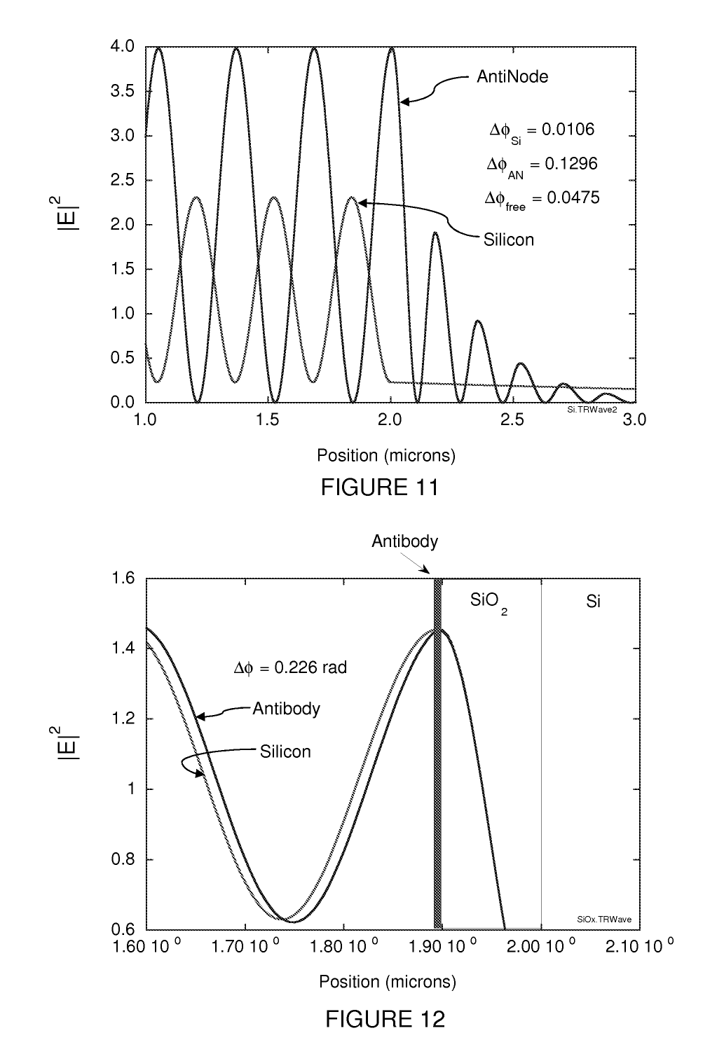

Silicon is one of the most common materials available because of its importance to the electronics industry. It therefore is a good substrate choice for economic reasons, as well as for its compatibility with anti-reflection coatings. FIG. 10 depicts the field strength at the surface of bare silicon showing real and imaginary components and magnitude. The field strength is low, at 48% of a perfect anti-node condition. This can be ameliorated by growing an oxide layer on top of the silicon. A biolayer of 8 nm thickness with a refractive index of 1.3 gives a phase shift in free space of 2*(n−1)*d*2*π/λ=0.048 rad. FIG. 11 depicts the squared field strength at a silicon surface compared to an anti-node surface. The squared field on silicon is 60% of the anti-node case. The calculated phase shift for silicon is 8% of the anti-node case. Hence bare silicon is not a useful surface for interferometry.

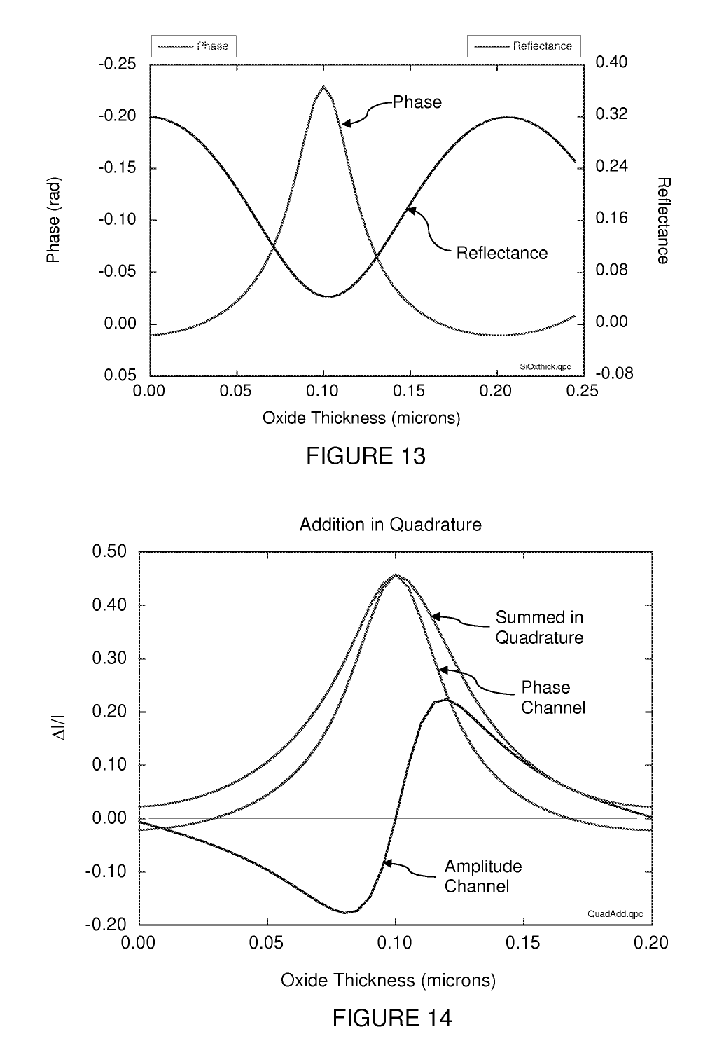

On the other hand, thermally-grown silicon dioxide on silicon provides a strong refractive index difference between both air/oxide and oxide/silicon interfaces. When the oxide thickness is a quarter-wavelength λ/4*N (N being an odd integer) in thickness, the electric field is a maximum at the oxide surface (anti-node) where the field is maximally sensitive to an added biolayer. This is illustrated in FIG. 12 showing the electric field strength for a quarter-wave oxide on silicon with and without an antibody layer. The surface is anti-nodal and hence has a field maximum and the condition of differential phase contrast. The phase shift is 0.226 rad caused by the biolayer, which is about 20 times larger than for bare silicon (which has nearly a nodal surface). The sensitivity of phase and reflectance as a function of the oxide thickness on silicon is shown in FIG. 13. The near-anti-reflection condition is at the quarter-wave thickness of 100 nm.

The intensity modulation in response to an 8 nm monolayer of antibody is shown in FIG. 14 as a function of the oxide thickness. FIG. 14 shows the phase channel (assuming quadrature detection of the phase modulation), the amplitude channel (detecting the full far-field intensity), and a quadrature sum of these two channels. An interesting application of the summed quadratures occurs if the disk thickness is varied across the disk. The summed quadrature is less sensitive to thickness variations than either of the individual channels. Note that the differential phase contrast channel for a thick biolayer can have over 30% intensity modulation. When summed in quadrature, the combined channels have a broad bandwidth that provides stability against varying oxide thickness across the wafer.

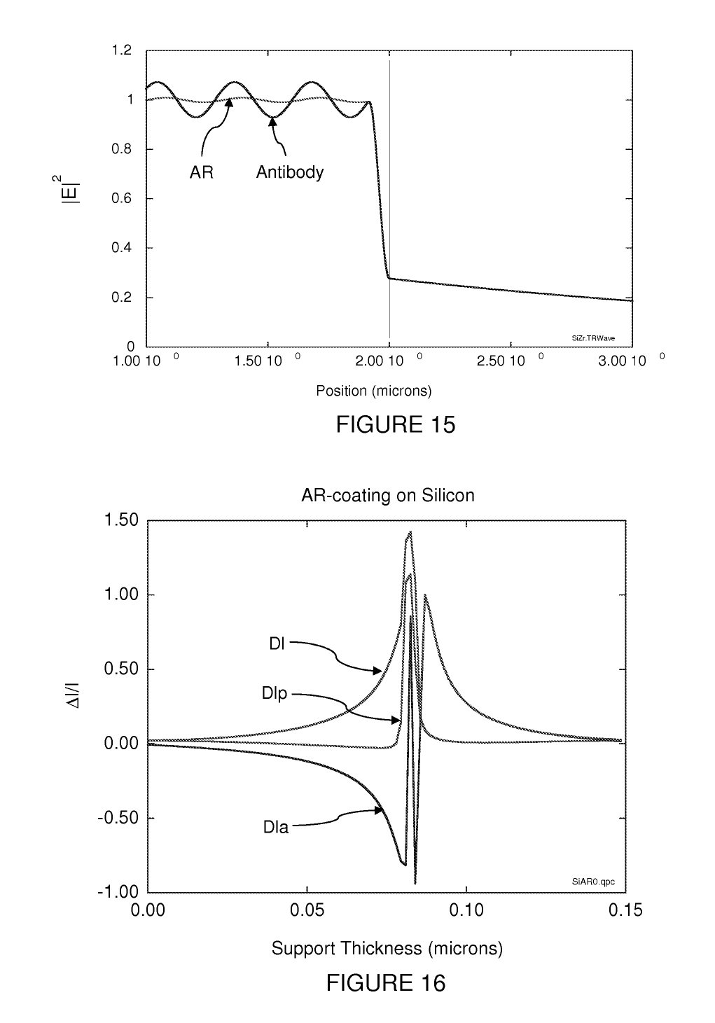

In the limit of an anti-reflection coating on silicon, the relative modulation can be arbitrarily large. This is illustrated in FIGS. 15 and 16. FIG. 15 shows the electric field for an anti-reflection-coated silicon surface. The electric field for an antireflection condition is nearly unity (no reflection), but this condition is spoiled by the antibody layer that reflects light. FIG. 16 shows the differential intensity modulation caused by the antibody biolayer. The differential intensity modulation can be arbitrarily large because the original reflectance can be arbitrarily close to zero. Phase wrapping occurs in this case, as shown in FIG. 16, with multiple peaks as a function of oxide thickness. The intensity modulation can be over 100%.

The in-line intensity channel in FIG. 14 shows the performance of the new quadrature class called In-Line Quadrature. In the far field, without any apertures or split detectors, the phase modulation caused by the biolayer is converted directly to intensity modulation. The peaks of this in-line response occur at 80 nm and 120 nm.

The quadrature condition for in-line detection is at approximately an eighth-wave thickness, for λ/8*N where N is an odd number and the wavelength is the wavelength in the support layer (free-space wavelength divided by the refractive index of the layer). The field amplitude is maximum (anti-node) at a quarter wave, and decreases to zero at zero-wave or half-wave. Therefore, there is a trade-off in the in-line quadrature detection, between field strength at the surface (the biolayer location), and the in-line quadrature detection condition (at eighth-wave thickness). This trade-off is optimized at approximately 80 nm (0.2λ) and 120 nm (0.3λ) for λ=635 nm and nₛ=1.5 for SiO₂, where there is partial phase shift between the signal and the reference while still having high field to sense the presence of the biolayer. The phase shift at these locations is not λ/2, but closer to π/2.5 or 72°. Therefore, although the detection is only approximately in quadrature, there is a reasonable proximity to quadrature (within 20%) to continue to merit the appellation “quadrature.”

One embodiment of the in-line quadrature class uses a silicon wafer coated by a layer of SiO₂ as a substrate for immobilized biomolecules. The thickness of the SiO₂ layer is chosen so that light reflected from the SiO₂ surface on top and light reflected from the silicon surface below is approximately in phase quadrature. Protein molecules scatter the incident light, adding a phase shift linearly proportional to the mass density of the immobilized protein, which is converted to a far-field intensity shift by quadrature interference. Patterning of protein can be done by spot printing with a jet printer, which can produce protein spots 0.1 mm in diameter.

In quadrature interference, the presence of protein causes a phase shift in the signal beam that interferes with a reference beam that is phase shifted by about π/2 or 3π/2. An embodiment using common-path interferometry produces both the signal and the reference beam locally so that they share a common optical path and the relative phase difference is locked at about π/2, unaffected by mechanical vibration or motion. By working at quadrature, the total interference intensity shift changes linearly and with maximum slope as a function of the phase shift caused by proteins. By working with a high-speed spinning disc, the typical 1/f system noise has a 40 dB per octave slope, and at a frequency well above the 1/f noise, a 50 dB noise floor suppression can be obtained, making it possible to measure protein signals with high precision.

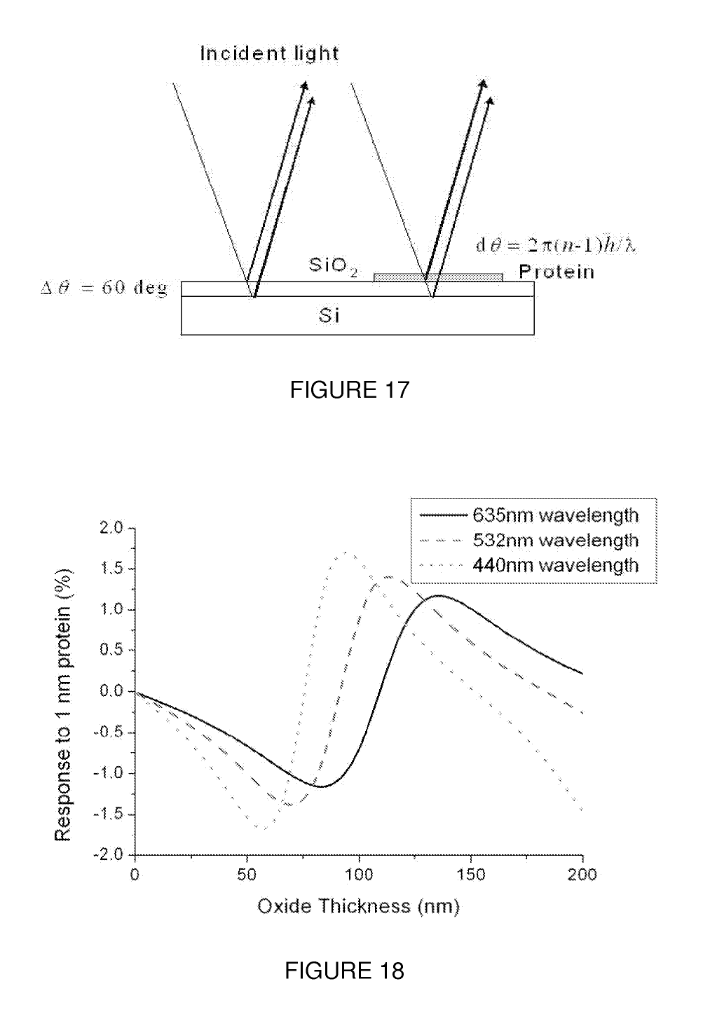

FIG. 17 shows a schematic of light rays reflected from the disk structure of an embodiment of an in-line quadrature system. It is based on the quadrature interference of light reflected from the top oxide (SiO₂) surface and from the bottom silicon (Si) surface. The phase difference of these two beams is set by the oxide thickness. When the oxide thickness is approximately λ/8 or 3λ/8, the two beams are in quadrature. The presence of protein scatters the incident beam and adds an optical phase shift, which is then converted to a far-field intensity shift. The intensity shift not only depends on the quadrature interference, but also on the surface electric field strength, and the actual protein signal is a combination of these two factors. A theoretical curve of the intensity shift caused by 1 nm of protein versus oxide thickness is shown in FIG. 18, for several different wavelengths.

In-line quadrature disks can be fabricated from 100-mm diameter silicon wafers with a layer of thermal oxide. The thickness of the SiO₂ layer is chosen to be 80 nm or 120 nm to obtain close to a π/2 or 3π/2 phase quadrature condition when using a 635 nm wavelength divided by the refractive index of silica. The 3π/2 quadrature is preferred, because by working at this quadrature, the intensity shift caused by the presence of protein is positive, thus easily distinguishing it from scattering from dust or salt particles, which has negative signal. Note that there is not a linear relationship between phase shift and layer thickness, which is why the two quadrature conditions occur at thicknesses of 0.2λ and 0.3λ, approximately, instead of 0.125λ and 0.375λ, where λ is again the free-space wavelength divided by the refractive index. The SiO₂ surface can be functionalized with an isocyanate coating which binds protein covalently.

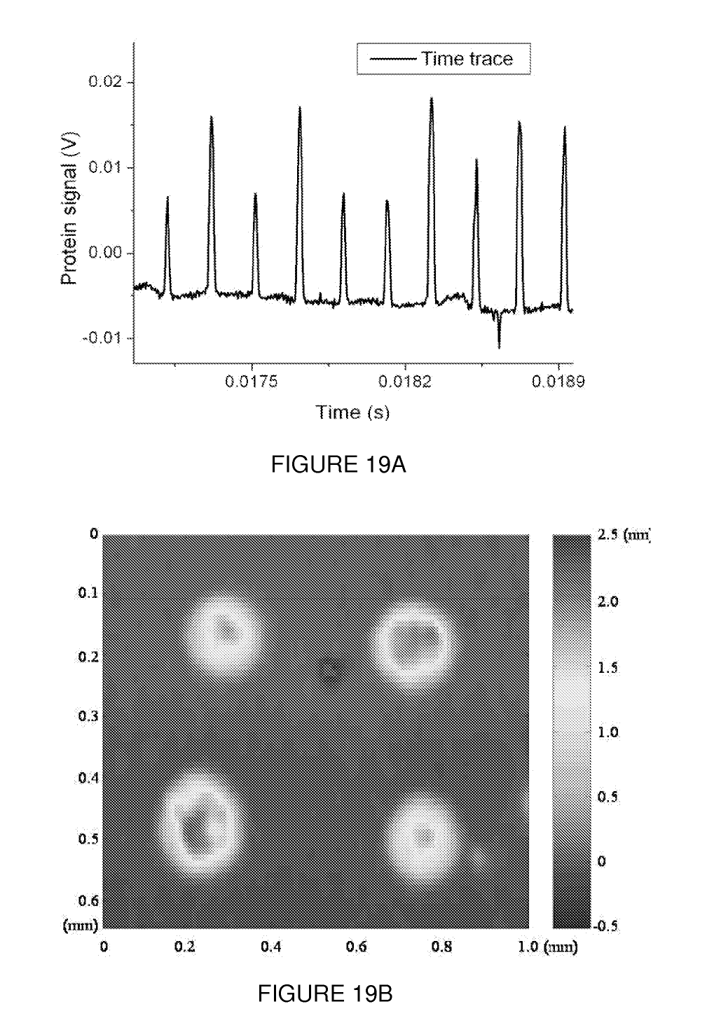

In one embodiment, the optical detection system uses a 635 nm diode laser as the light source. The laser beam is focused onto the disc by a 5 cm focal length objective to a 20 micron diameter. The disc is mounted on a stable spinner, such as one available from Lincoln Laser Inc. of Phoenix, Ariz., and spun at 20 Hz. The reflected light from the disc is collected by the same objective and directed to a photodetector by a beam splitter. In this embodiment, the detector is a quadrant detector that has three output channels: one total intensity channel and two difference channels (left minus right, and top minus bottom). For in-line operation, only the summed intensity channel is used for detection, while the other two channels provide diagnostics for optical alignment. The intensity shift produced by protein is measured directly as a time trace of total light intensity, as shown in FIG. 19A. A two dimensional surface profile can be obtained by putting time traces taken at consecutive radii together into a 2D display, as is shown in FIG. 19B. The lateral resolution of the scanning is the same as the beam width, which in this case is 20 microns.

The detection sensitivity of the in-line quadrature system can be measured by scanning over a single track multiple times and taking the difference between the scans. The detection sensitivity improves with averaging by the square root of the number of averages and can be as sensitive as 10 pm per laser spot before the averaging time takes too long and systematic drifts begin to dominate. In one experimental protocol, the detection sensitivity is 20 pm per laser spot with sixteen averages, which correspond to about 6 femtograms of minimum detectable protein mass per laser focus. In order to scale this mass sensitivity to a larger area, one must consider the effect of averaging over the detection area. By assuming an uncorrelated random distribution of surface roughness, when scanning over a larger area, the standard error of the measurement decreases by a factor of the square root of the area. By using this criteria, the mass sensitivity is scaled to 0.3 pg/mm².

The protein pattern in FIG. 19B is printed by a piezoelectric inkjet protein printer produced by Scienion Inc. and distributed by BioDot. Each spot is printed with 300 pL of protein solution, resulting in a 100 μm diameter spot on the isocyanate coating. Over 25,000 spots can be printed on a single silicon wafer, allowing room for highly multiplexed assays.

To demonstrate the assay sensitivity of the in-line quadrature biological disc, we have performed a dose response experiment with an equilibrium reverse immunoassay. A disc was prepared with isocyanate coating and printed with more than 25,000 spots of mouse and rabbit IgG antigen, arranged in a radial pattern of grids, with 100 radial tracks along the radius and 256 spots in each track. The spots are grouped into 2×2 unit cells, in which two mouse spots are printed in one diagonal and two rabbit spots in the other diagonal. The disc was first globally incubated in 10 ng/ml casein in a 10 mM Phosphate Buffered Saline (PBS) solution with 0.05% Tween 20, setting the baseline of the measurements. The disc was then globally incubated with increasing concentrations from 100 pg/ml to 100 ng/ml of anti-mouse IgG, in PBS buffer with 0.05% Tween 20 and 10 ng/ml of casein. Each incubation lasted for 20 hours on a orbital shaker (VWR) to ensure the system reaches equilibrium and is not limited by mass transport to the disc surface. The disc was scanned after each incubation. The antibody-antigen binding was analyzed by first comparing each scan with the prescan before incubation, dividing the protein height changes by the prescan protein height for all the spots to get the ratio of height change for each spot, and then taking the difference of this height change ratio between the specific (mouse) and non-specific (rabbit) spots. This relative difference in height change is defined as the assay signal. For example, an assay signal of 0.1 means that the specific spots gains 10% more mass than the nonspecific spots. This analysis provides good rejection of systematic shifts, wash-off effects, and non-specific binding that is common to both groups of spots.

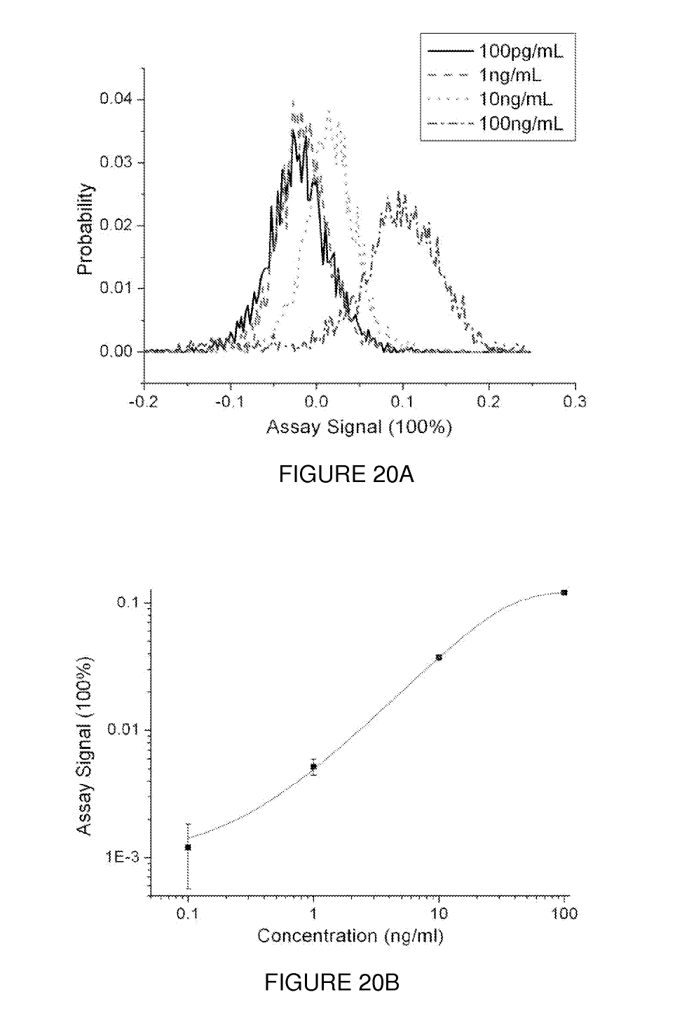

The result of the dose response curve experiment is shown in FIGS. 20A and 20B. Histograms of assay signal in each unit cell as a function of dose are shown in FIG. 20A, and the dose response curve is shown in FIG. 20B. A dose response curve is obtained by fitting a Gaussian to each of the distributions, and the centers of the Gaussian fit are used as the average assay signals. The error bars of the data points in FIG. 20B are set by the standard error of the measurements. The sensitivity of the current system is 100 pg/ml, when the dose response curve runs into the detection baseline. At this concentration level, the average detected protein mass change per spot is only 20 femtograms. The dose response curve saturates at 16% mass increase, suggesting a 10-percent biological activity of the printed protein.

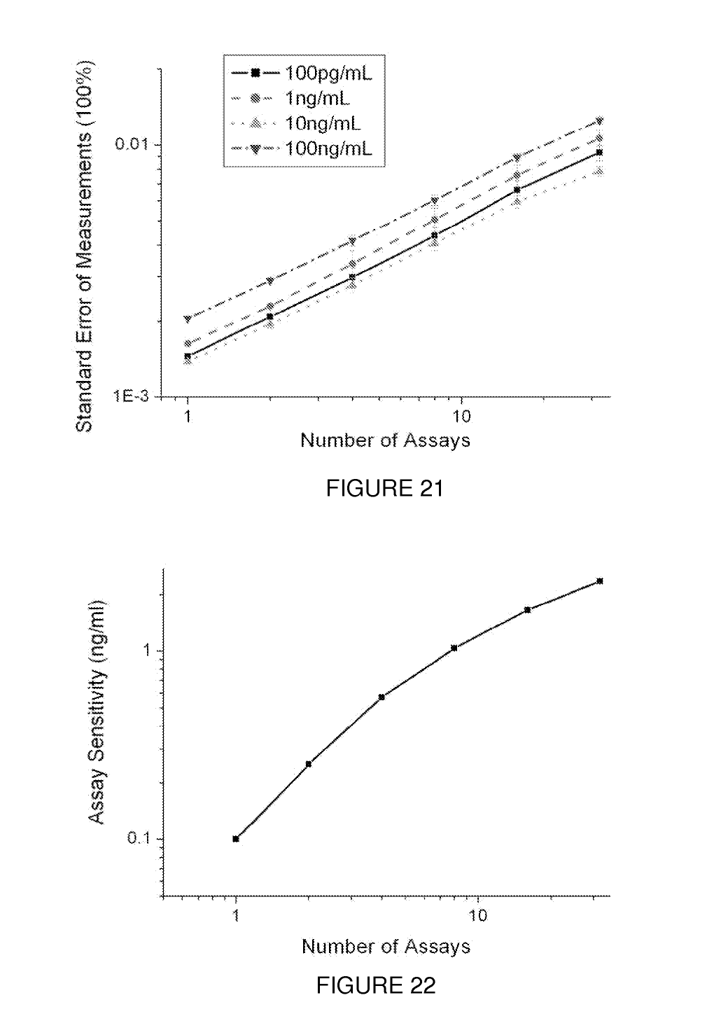

A scaling analysis was performed by dividing the disc into a number of virtual “wells” and treating each of them as independent assays. By increasing the number of assays per disc, the number of spots used per assay decreases, so the uncertainty of the assay increases. FIG. 21 shows the standard error of the assay versus the number of assays per disc. The error bars in this figure are set by the statistics over different wells of assays. The standard error increases as the square root of the number of assays, suggesting that the system is unbiased and that the measurement noise is uncorrelated. This standard error sets the detection limit of the assay, and combining this with the dose response curve, the sensitivity limit of the assays can be obtained as a function of the number of assays per disc, as shown in FIG. 22. This detection limit has contributions from the noise increase and from the shape of the dose response curve. As an example, if thirty-two different assays were performed on this disc, then the detection limit for each assay would be 2 ng/ml. By further extrapolating this curve, if a single unit cell were treated as an independent assay, then the sensitivity of this assay would be about 10 ng/ml.

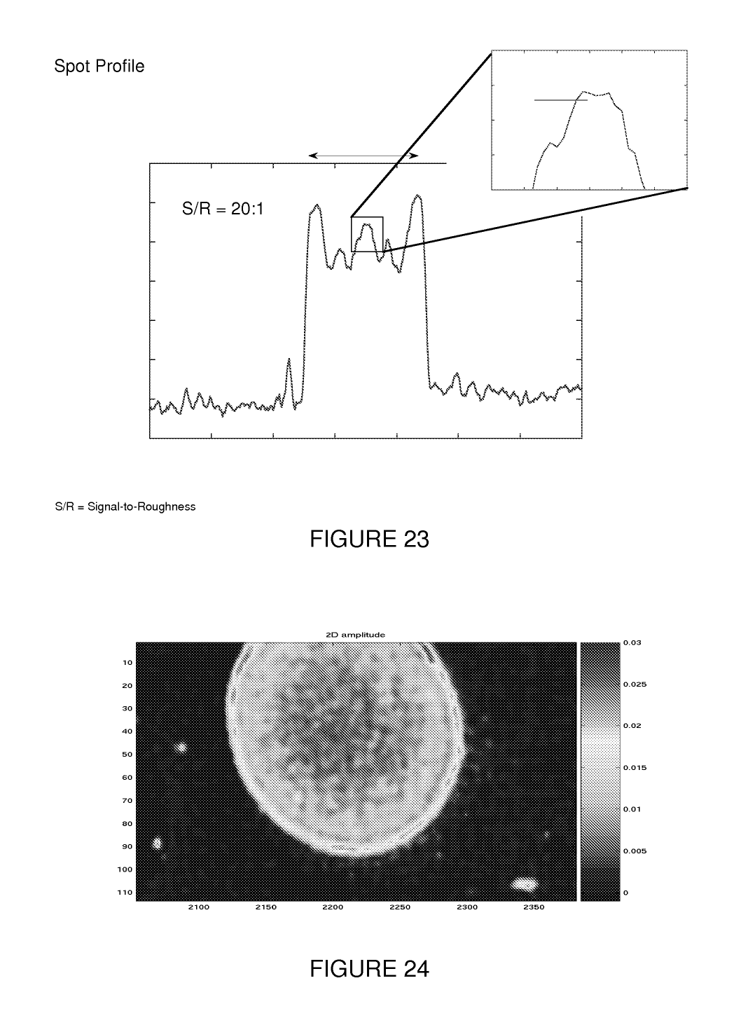

In another embodiment, silicon dioxide grown thermally on silicon wafers was obtained with an oxide thickness of 80 nm, in condition for in-line detection. Proteins were spotted onto these wafers in individual spots using a Deerac printer. The far-field scanning in this case was unapertured, collecting the full intensity. Clear modulation of the intensity is caused by the immobilized protein spots on the wafer surface as shown in FIGS. 23 and 24. FIG. 23 shows a cross-section across a single spot showing an outer ridge and internal ridges. The protein variation is resolvable down to 100 pm. FIG. 24 shows a high-resolution scan of a spot with a clear ring structure.

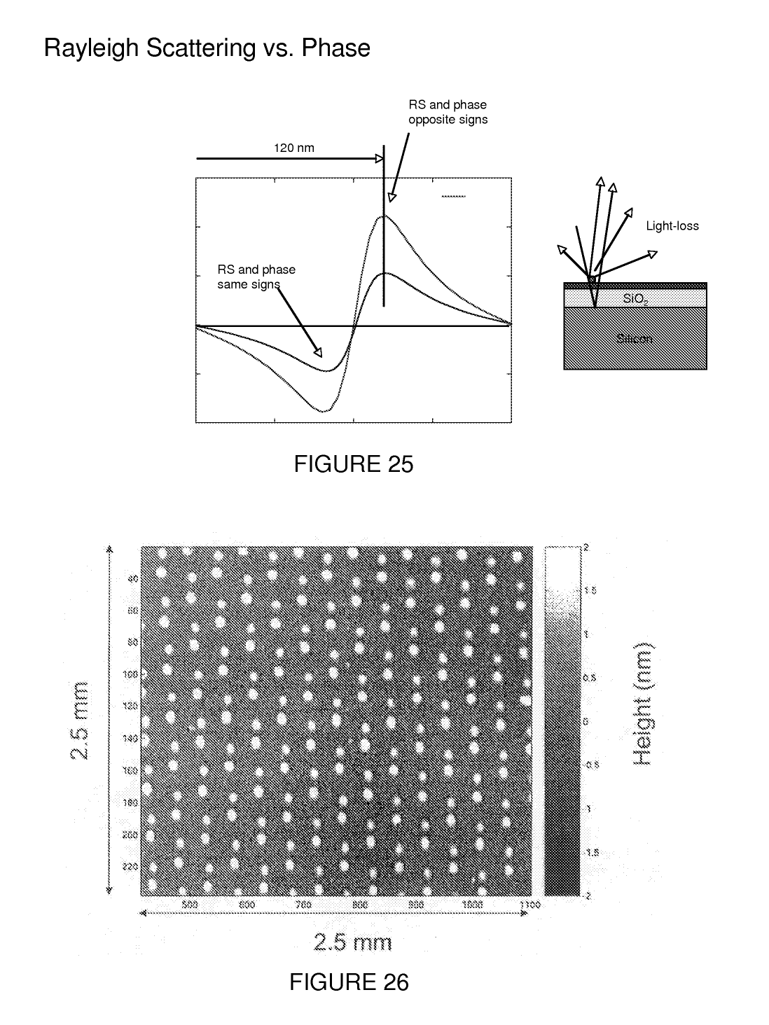

An alternative embodiment of the disk changes the oxide thickness from 80 nm to 120 nm. As shown in FIG. 25, at 120 nm the sign of the signal caused by molecular phase shifts contrasted to Rayleigh scattering (that removes light from the detected beam) are opposite. The scattering of energy out of the reflected beam is negative, while added protein load on the surface is positive. This improves discrimination between molecular phase and Rayleigh scattering, and makes it possible to discriminate between added mass (phase load) and light scattering. Scattering losses are always negative, while added protein load on a 120 nm oxide disk produces a positive shift in the intensity. This principle has been demonstrated experimentally. A scan of about 200 protein spots (120 micron diameter IgG spots on a 120 nm oxide biological disc) is shown in FIG. 26. The protein spots (about 3 nm high) are bright, while the small dust and debris show as black specks.

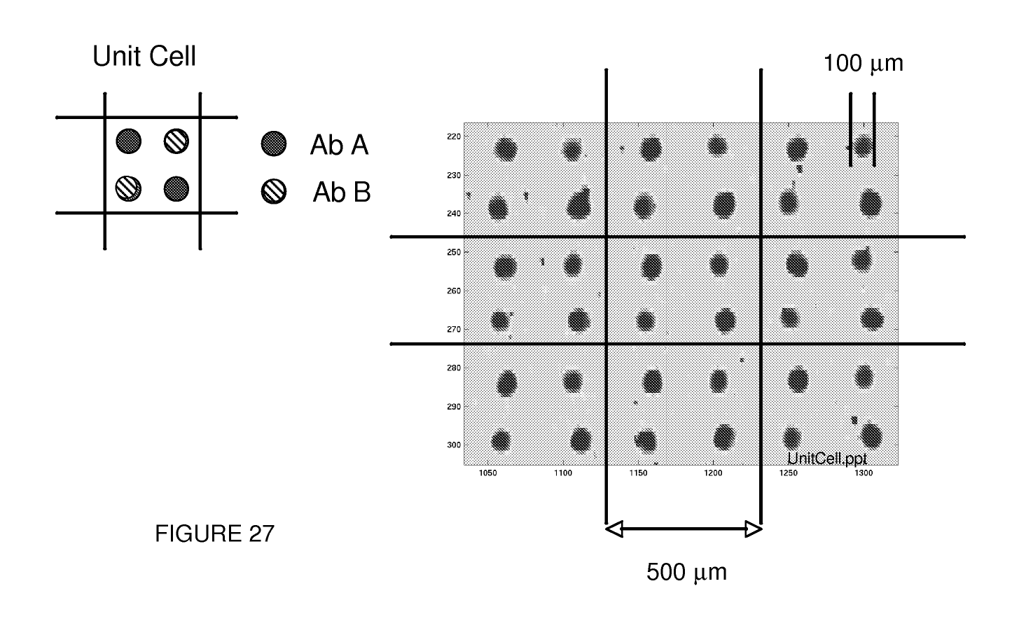

Another feature of direct detection is reference subtraction which subtracts the common-mode effects such as non-specific binding. The inline detection can use the principle of differential encoding, such as shown in U.S. patent application Ser. No. 11/345,566 entitled “Differentially Encoded Biological Analyzer Planar Array Apparatus and Methods,” which was previously incorporated by reference. One embodiment of differential encoding is the 2×2 unit cell shown in FIG. 27. The example of a “unit cell” shown in FIG. 27 has target and reference spots placed in a 2×2 array. The data on the right is data of unit cell spots of approximately 120 micron diameter printed onto a 120 nm oxide biological disc. Two similar proteins are spotted in a 2×2 array pattern. One set is specific to the analyte, while the other set has similar properties, but is not specific to the analyte. When incubated, common non-specific binding increases both spot heights similarly, but the specific spot height increases more because of the specific binding to the analyte. By taking the difference in the diagonal sums:

$${R}_{i} = \frac{( {A}_{1} + {A}_{2} ) - ( {B}_{1} + {B}_{2} )}{{A}_{1} + {A}_{2} + {B}_{1} + {B}_{2}}$$

the common non-specific binding can be subtracted directly, and the remainder Rᵢ is the specific binding in that unit cell.

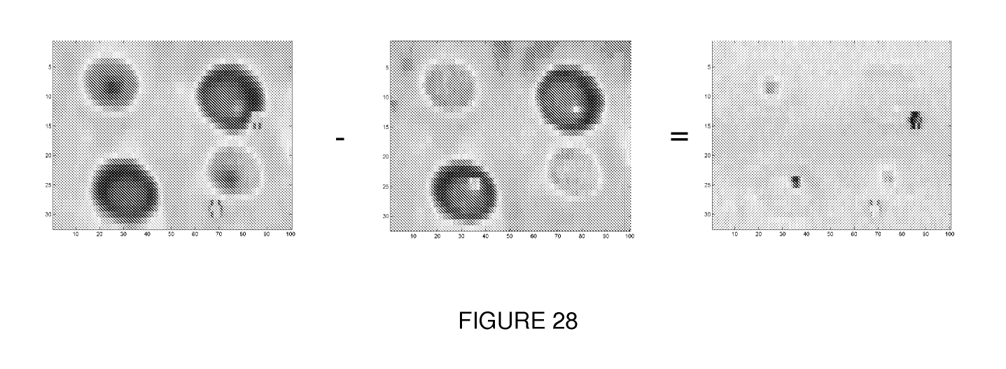

An additional procedure that can be used to help reduce background noise and common drifts of the land caused by incubation steps is direct image subtraction. This is illustrated with data in FIG. 28 which shows a prescan image in the middle being subtracted from a postscan image on the left (after incubation for 20 hours with 100 ng/ml IgG in casein buffer). The resultant difference image on the right shows the change in surface height. The difference image shows clearly that the upper-left/lower-right spots have gained mass relative to the 2 spots on the alternate diagonal. The effect of dust is also evident in the difference. The diagonal difference of the unit cell described above can be applied to the difference image to further isolate the effects of specific binding relative to non-specific binding and land drift.

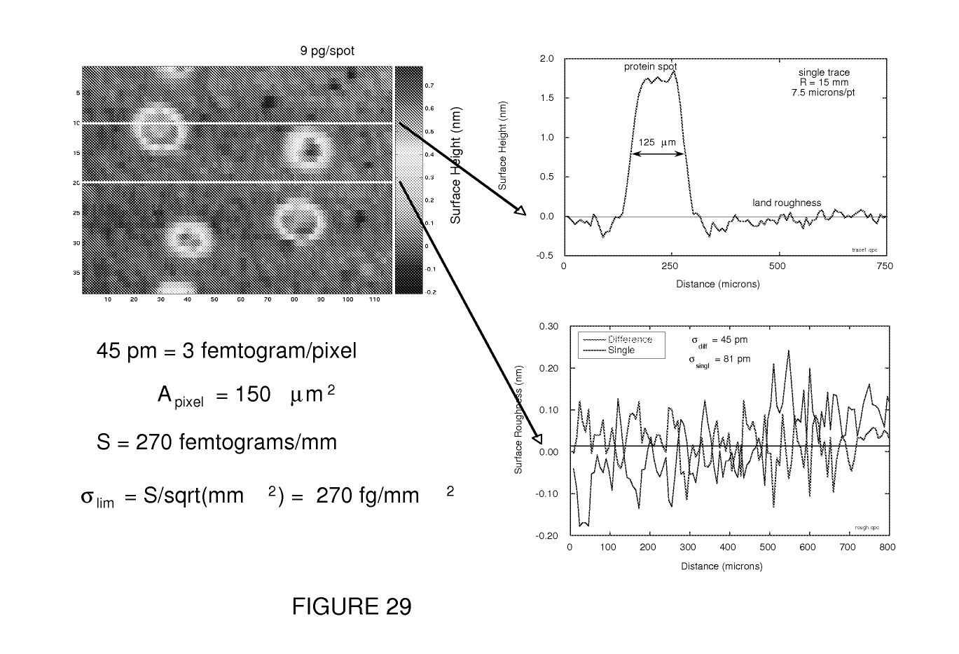

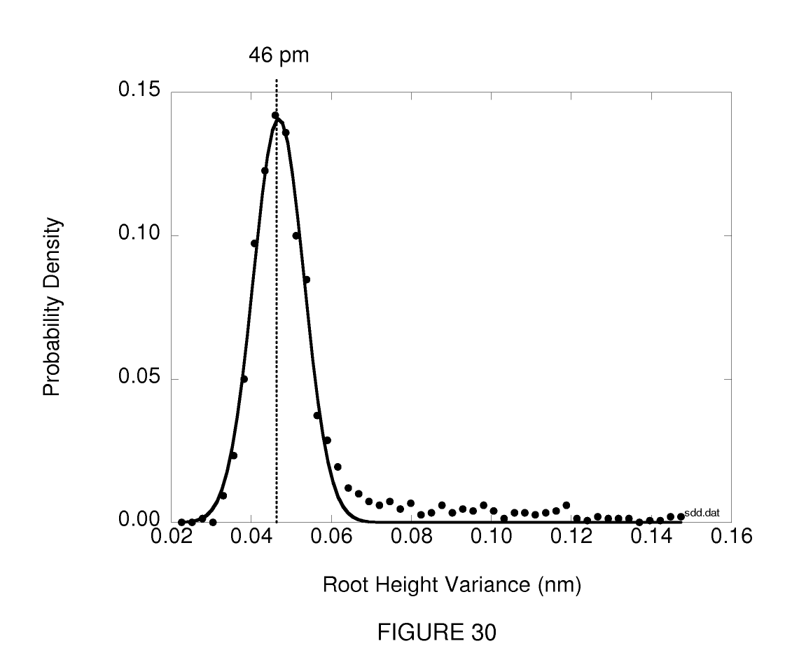

We assume that the surface height shifts caused by the 20 hour wash in buffer are random and uncorrelated between the successive scans of the biological disc surface height distribution. This assumption is likely to be valid for usual conditions encountered with the biological disc. An example of surface roughness that sets the limit of protein detection is shown in FIG. 29. FIG. 29 graphs sample data showing the detection sensitivity of in-line quadrature on a 120 nm oxide biological disc. The scan data on the upper left gives two line plots on the right, one through the center of an IgG spot, and the other on the so-called land. The roughness is converted into a mass sensitivity of about 0.27 pg/mm². The histogram in FIG. 30 shows the root variance in the surface height between two scans of the same disc before and after a 20 hour buffer wash, which was determined to be 46 picometers per focal spot, corresponding to 5 femtograms of protein per focal spot with a diameter of 15-20 microns.

To compare with other surface mass detection techniques, such as surface plasmon resonance, this number needs to be scaled correctly to the corresponding sizes because the accuracy of a measurement improves by the square root of the sensor area. The scaled surface height sensitivity at the scale of 1 mm is given by:

$$Δ {h}_{mm} = Δ {h}_{meas} \sqrt{\frac{{a}_{foc}}{1 {mm}^{2}}}$$

where a_{foc} is the area of the focused laser spot and Δhₘₑₐₛ is the root variance in the height difference. For Δhₘₑₐₛ=46 pm and a_{foc}=200 μm² this gives Δhₘₘ=0.65 pm. It is interesting to note that this average surface height sensitivity is less than the radius of a proton, although this is clearly possible because of the averaging over a full square millimeter. The mass associated with this protein height is:
Δmₘₘ=Δhₘₘρₘ1 mm²
which, for Δhₘₘ=0.65 pm gives Δmₘₘ=0.25 pg. To obtain the general scaling for the surface mass sensitivity when performing measurements at an area scale A, these equations can be combined to give:
Δm_{A}=Δhₘₑₐₛρₘ\sqrt{Aπwₘₑₐₛ²}
from which the sensitivity is determined as:

$$S = \frac{Δ {m}_{A}}{\sqrt{A}} = {ρ}_{m} Δ {h}_{meas} {w}_{meas} = 0.25 pg \text{/} mm$$

which has the units of mass per length.

For a single assay that measures over an area A, the minimum captured mass that can be detected from that assay is given by:
Δm_{A}=S\sqrt{A}

As an example, if the assay area is 1 mm², then the detected mass is 0.25 pg. Similarly, to obtain the minimum detectable surface mass density the scaling sensitivity is divided by the square-root of the sensing area. For a square millimeter this is:

$${S}_{mm} = \frac{S}{\sqrt{1 mm}} = 0.25 pg \text{/} {mm}^{2}$$

This area-dependent sensitivity is comparable to the best values determined by surface plamon resonance (SPR). This sensitivity is gained without the need for resonance and hence is much more robust and easy to manufacture than other interferometric or resonance approaches.

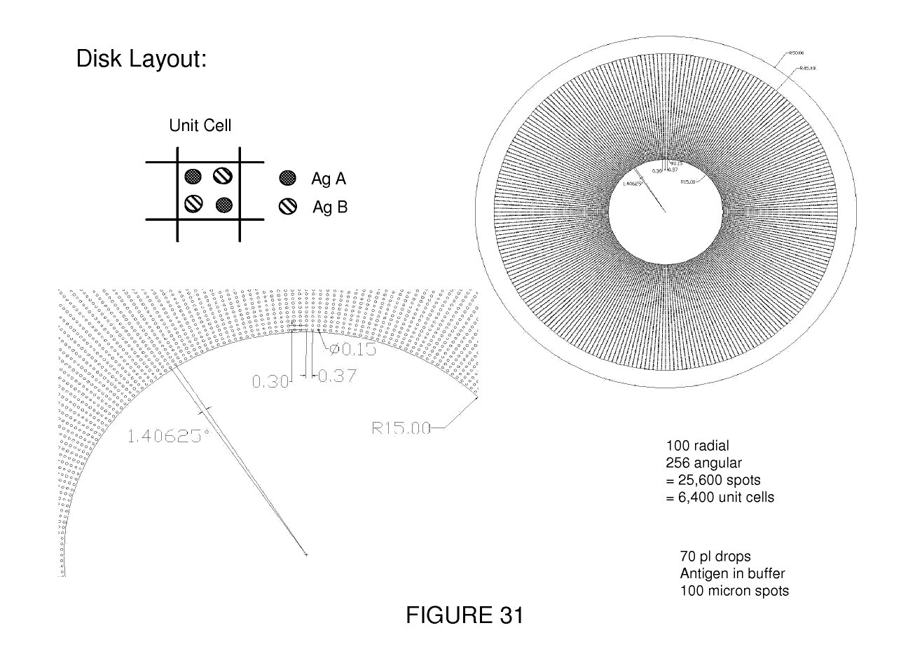

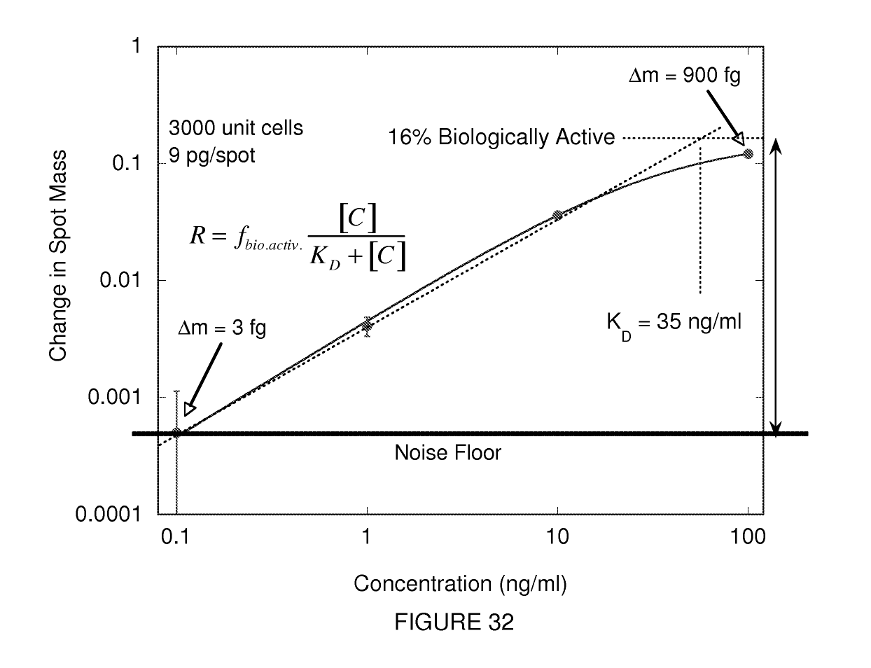

The dose-response curve of a 120 nm oxide biological disc is obtained by printing spots in the 2×2 unit cell pattern on a disc. An example of the spot layout is shown in FIG. 31. In this example the disc is spotted with 25,600 spots in 100 radial steps and 256 angular steps. This produces 6,400 unit cells. A dose-response curve was obtained by sequentially incubating the entire disc with increasing concentrations of analyte (anti-rabbit) in 10 ng/ml casein in PBS. The resulting dose response curve is shown in FIG. 32 using approximately 3,000 of the spots. FIG. 32 presents assay data showing change in spot mass as a function of analyte concentration for a series of incubations on a 120 nm oxide disc. The smooth curve is a Langmuir function fit to the data. The parameters of the function are k_{D}=35 ng/ml, the limit-of-detection=3 fg per spot and a biological activity of 16%. The dynamic range between saturation and the limit-of-detection is about 300:1. These numbers are not fundamental and are subject to improvement and are shown here only as an example of the experimental performance of the in-line biological disc.

While the present system is susceptible to various modifications and alternative forms, exemplary embodiments thereof have been shown by way of example in the drawings and are herein described in detail. It should be understood, however, that there is no intent to limit the system to the particular forms disclosed, but on the contrary, the intention is to address all modifications, equivalents, and alternatives falling within the spirit and scope of the system as defined by the appended claims.

What is claimed is:

1. An apparatus for use with a probe beam and a detector that detects the probe beam waves for detecting the presence of a target analyte in a sample, the apparatus comprising:
a substrate;
a biolayer designed to react to the target analyte when the sample is deposited on the biolayer, the biolayer being located on the substrate;
wherein the substrate is selected to substantially minimize the reflectance of the probe beam waves by the substrate while substantially maintaining the scattering of the probe beam waves by the target analyte.

2. The apparatus of claim 1, wherein the substrate is designed such that the probe beam waves reflected by the substrate are substantially in quadrature with the probe beam waves scattered by the target analyte.

3. The apparatus of claim 1, wherein the substrate is designed such that the probe beam waves reflected by the substrate and the probe beam waves scattered by the target analyte interfere in the far field and directly create intensity modulation detectable by the detector.

4. The apparatus of claim 3, wherein the substrate is designed such that the probe beam waves scattered by the target analyte interfere constructively in the far field with the probe beam waves reflected by the substrate to increase intensity modulation, and the probe beam waves scattered by a dust particle on the substrate produce an intensity decrease in the far field.

5. The apparatus of claim 1, wherein the substrate is designed such that the probe beam waves scattered by the target analyte are substantially in-phase with the probe beam waves reflected by the substrate.

6. The apparatus of claim 1, wherein the biolayer comprises a plurality of spots deposited on the substrate, and the detector detects when the target analyte reacts with one of the plurality of spots.

7. The apparatus of claim 6, wherein the plurality of spots are grouped into unit cells, each unit cell comprising spots having specific antibodies and spots having non-specific antibodies.

8. The apparatus of claim 7, wherein each unit cell is a two-by-two array of spots having a first diagonal and a second diagonal, the first diagonal comprising a pair of spots having specific antibodies and the second diagonal comprising a pair of spots having non-specific antibodies.

9. The apparatus of claim 8, wherein the detector provides a reading for each of the plurality of spots in the unit cell and a diagonal difference is computed, the diagonal difference being the sum of the readings from the pair of spots on the second diagonal having non-specific antibodies subtracted from the sum of the readings for the pair of spots on the first diagonal having specific antibodies and the computed difference being divided by the sum of the readings from all four spots.

10. The apparatus of claim 1, wherein the apparatus is a disc.

11. The apparatus of claim 1, wherein the probe beam is a substantially monochromatic laser and the apparatus further comprises:
an objective lens for collecting a target signal, the target signal comprising the probe beam waves scattered by the target analyte and the probe beam waves reflected by the substrate; and
a beam splitter for directing the target signal to the detector.

12. The apparatus of claim 11, further comprising a spinning mechanism, wherein the substrate is spun by the spinning mechanism such that the probe beam waves hit the substrate and the sample as they are spinning, and the reflected and scattered probe beam waves impinge on the objective lens.

13. The apparatus of claim 12, wherein the apparatus is designed to reduce system noise such that relative intensity noise dominates system noise.

14. The apparatus of claim 13, wherein the biolayer comprises a plurality of spots grouped into unit cells, each unit cell comprising spots having specific antibodies and spots having non-specific antibodies.

15. The apparatus of claim 1, wherein the detector is a split detector having a left half output and a right half output and the difference between the left half output and the right half output is used for detecting the presence of the target analytes.

16. The apparatus of claim 1, wherein the detector is a quadrant detector having a total intensity output and two difference outputs and only the total intensity output is used for detecting the presence of the target analytes.

17. The apparatus of claim 1, wherein the detector is a multi-output detector having a total intensity output and a difference output, the total intensity output being usable to compute an in-line quadrature reading and the difference output being usable to compute a differential phase contrast reading.

18. The apparatus of claim 17, wherein the in-line quadrature reading and the differential phase contrast reading are summed in quadrature for detecting the presence of the target analyte.

19. The apparatus of claim 1, wherein the substrate comprises:
a base material, and
a support layer having a top support surface, a bottom support surface and a support layer thickness which is the distance between the top support surface and the bottom support surface, the support layer being located on the base material such that the bottom support surface is adjacent to the base material, and the biolayer being located on the top support surface.

20. The apparatus of claim 19, wherein the support layer is selected such that the refractive index of the support layer substantially minimizes reflectance of the probe beam waves by the top support surface and by the base material.

21. The apparatus of claim 20, wherein the support layer thickness is selected to tune the phase of the probe beam waves reflected by the top support surface and the probe beam waves reflected by the base material to bring them substantially into one of phase quadrature or in-phase.

22. The apparatus of claim 19, wherein the support layer thickness is selected such that the probe beam waves reflected by the top support surface are substantially in quadrature with the probe beam waves reflected by the base material.

23. The apparatus of claim 19, wherein the support layer thickness is approximately N*λ/4, where λ is the wavelength of the probe beam waves and N is an odd integer.

24. The apparatus of claim 19, wherein the support layer thickness is selected such that the probe beam waves reflected by the top support surface are substantially in phase with the probe beam waves reflected by the base material.

25. The apparatus of claim 19, wherein the support layer thickness is approximately N*λ/8, where λ is the wavelength of the probe beam waves and N is an odd integer.

26. The apparatus of claim 19, wherein the support layer thickness is selected to be between the optimum thickness for in-line quadrature detection and the optimum thickness to maximize electric field strength at the top support surface, inclusively.

27. The apparatus of claim 19, wherein the support layer thickness is approximately 0.2*λ where λ is the wavelength of the probe beam waves.

28. The apparatus of claim 19, wherein the support layer thickness is selected such that the probe beam waves scattered by the target analyte interfere constructively in the far field with the probe beam waves reflected by the substrate to increase intensity modulation, and the probe beam waves scattered by a dust particle on the support layer cause an intensity decrease in the far field.

29. The apparatus of claim 19, wherein the support layer thickness is approximately 0.3*λ, where λ is the wavelength of the probe beam waves.

30. The apparatus of claim 19, wherein the base layer and support layer materials are selected such that for the base material having a refractive index of n*n, the support layer is selected to have a refractive index of approximately n.

31. The apparatus of claim 19, wherein the base material is glass and the support layer is a thin layer of gold.

32. The apparatus of claim 31, wherein the thickness of the layer of gold is approximately 3 nm.

33. The apparatus of claim 19, wherein the support layer comprises quarter wave layers on the substrate designed to substantially minimize the reflectance of the probe beam waves by the substrate.

34. The apparatus of claim 19, wherein the support layer is MgF and the base material is ZrO₂.

35. The apparatus of claim 19, wherein the base material is silicon (Si) and the support layer is silicon dioxide (SiO₂).

36. A method for detecting the presence of a target analyte in a sample, the method comprising:
providing a substrate including a plurality of analyzer molecules distributed about the substrate;
contacting the sample to at least a portion of the analyzer molecules on the substrate;
scanning the substrate with waves from a probe beam;
collecting a target signal including probe beam waves reflected and scattered by the substrate and the sample; and
determining one of the presence or the absence of the target analyte in the sample directly from the intensity modulation of the target signal.

37. The method of claim 36, wherein the collecting step comprises.
collecting the probe beam waves scattered by the target analyte; and
collecting the probe beam waves reflected by the substrate.

38. The method of claim 37, wherein the probe beam waves scattered by the target analyte are substantially in-phase with the probe beam waves reflected by the substrate.

39. The method of claim 38, wherein the substrate is designed such that the probe beam waves scattered by the target analyte interfere constructively in the far field with the probe beam waves reflected by the substrate to increase intensity modulation, and the probe beam waves scattered by a dust particle on the substrate cause an intensity decrease in the far field.

40. The method of claim 36, wherein the scanning step further comprises:
placing the substrate on a spinning platform; and
spinning the substrate and the sample so the substrate is scanned by the probe beam.

41. The method of claim 36, wherein the plurality of analyzer molecules are distributed about the substrate in a plurality of spots organized into unit cells, and wherein each unit cell includes a two-by-two array of spots having a first diagonal and a second diagonal, the two spots on the first diagonal of the array being designed to react strongly with the target analyte, and the two spots on the second diagonal of the array being designed not to react strongly with the target analyte.

42. The method of claim 41, wherein the determining step further comprises:
taking measurements of the intensity signal from each spot; and
for each unit cell:
computing a first diagonal sum as the sum of the measurements from the two spots on the first diagonal;
computing a second diagonal sum as the sum of the measurements from the two spots on the second diagonal; and
taking the difference of the first diagonal sum and the second diagonal sum.

43. The method of claim 36, wherein the determining step further comprises:
measuring an in-line quadrature reading directly from the intensity modulation of the target signal;
measuring a differential phase contrast reading; and
computing a sum in quadrature of the in-line quadrature reading and the differential phase contrast reading.

44. The method of claim 36, further comprising:
pre-scanning the substrate prior to the contacting step;
making a pre-scan image of at least a portion of the analyzer molecules from the data collected in the pre-scanning step;
making a post-scan image of substantially the same portion of the analyzer molecules included in the pre-scan image;
registering the post-scan image with the pre-scan image;
making a difference image of the difference between the registered pre-scan image and post-scan image; and
using the difference image in the determining step.

45. A method of designing a platform for detecting the presence of a target analyte in a sample, the method comprising:
providing a substrate;
depositing a plurality of target spots on the substrate;
depositing a plurality of reference spots on the substrate, each of the plurality of target spots being configured to react relatively strongly with the target analyte and each of the plurality of reference spots being configured to react relatively weakly with the target analyte;
grouping the plurality of target spots and the plurality of reference spots into unit cells, each unit cell comprising at least one target spot and at least one reference spot.

46. The method of claim 45, wherein each of the plurality of target spots include specific antibodies designed to specifically bind with the target analyte and the plurality of reference spots include non-specific antibodies not designed to specifically bind with the target analyte.

47. The method of claim 45, wherein each unit cell is a two-by-two array of spots having a first diagonal and a second diagonal, the first diagonal comprising two target spots and the second diagonal comprising two reference spots.

48. The method of claim 45, wherein the providing step further comprises:
providing a base material,
providing a support layer having a top support surface, a bottom support surface and a support layer thickness which is the distance between the top support surface and the bottom support surface;
positioning the support layer on the base material such that the bottom support surface of the support layer is adjacent to the base material; and
conditioning the support layer to accept the plurality of target spots and the plurality of reference spots.

49. The method of claim 48, further comprising:
selecting the support layer and the base material combination to substantially minimize reflectance of the probe beam waves by the top support surface and by the base material.

50. The method of claim 48, further comprising:
selecting the support layer thickness to tune the phase of the probe beam waves reflected by the top support surface and the probe beam waves reflected by the base material to bring them substantially into one of phase quadrature or in-phase.

51. The method of claim 48, further comprising:
selecting the base material and the support layer such that for the base material having a refractive index of n*n, the support layer is selected to have a refractive index of approximately n.

52. The method of claim 48, further comprising:
making the support layer thickness approximately the thickness at which the probe beam waves reflected by the top support surface are substantially in quadrature with the probe beam waves reflected by the base material.

53. The method of claim 48, further comprising:
making the support layer thickness approximately the thickness at which the probe beam waves reflected by the substrate and the probe beam waves scattered by the target analyte interfere in the far field and directly create intensity modulation detectable by the detector.

54. The method of claim 48, further comprising:
making the support layer thickness approximately N*λ/4, where λ is the wavelength of the probe beam waves and N is an odd integer.

55. The method of claim 48, further comprising:
making the support layer thickness approximately the thickness at which the probe beam waves scattered by the target analyte interfere constructively in the far field with the probe beam waves reflected by the substrate to increase intensity modulation, and the probe beam waves scattered by a dust particle on the substrate decrease intensity in the far field.

56. The method of claim 48, further comprising:
making the support layer thickness approximately the thickness at which the probe beam waves scattered by the target analyte are substantially in-phase with the probe beam waves reflected by the substrate.

57. The method of claim 48, further comprising:
making the support layer thickness approximately N*λ/8, where λ is the wavelength of the probe beam waves and N is an odd integer.

58. The method of claim 48, further comprising:
making the support layer thickness between the optimum thickness for in-line quadrature detection and the optimum thickness to maximize electric field strength at the top support surface, inclusive.

59. The method of claim 48, further comprising:
making the support layer thickness approximately 0.2*λ, where λ is the wavelength of the probe beam waves.

60. The method of claim 48, further comprising:
making the support layer thickness such that the probe beam waves scattered by the target analyte interfere constructively in the far field with the probe beam waves reflected by the substrate to increase intensity modulation, and the probe beam waves scattered by a dust particle on the support layer cause an intensity decrease in the far field.

61. The method of claim 48, further comprising:
making the support layer thickness approximately 0.3*λ, where λ is the wavelength of the probe beam waves.
